(19) United States
(12) Patent Application Publication
(10) Pub. No.: US 2018/0295595 A1
(43) Pub. Date: Oct. 11, 2018

(54) EFFICIENT SYNCHRONIZATION FOR WAKEUP RADIO

(71) Applicant: QUALCOMM Incorporated, San Diego, CA (US)

(72) Inventors: Stephen Jay Shellhammer, Ramona, CA (US); Yanjun Sun, San Diego, CA (US); Abhishek Pramod Patil, San Diego, CA (US); George Cherian, San Diego, CA (US); Alfred Asterjadhi, San Diego, CA (US); Bin Tian, San Diego, CA (US)

(21) Appl. No.: 15/944,543

(22) Filed: Apr. 3, 2018

Related U.S. Application Data
(60) Provisional application No. 62/482,122, filed on Apr. 5, 2017.

(51) Int. Cl. H04W 56/00; H04W 52/02; H04L 7/00

(52) U.S. Cl. CPC H04W 56/0015; H04W 52/0216; H04W 52/0206; H04W 52/0229; H04L 7/0008

(57) ABSTRACT

An access point (AP) may determine a time resolution for values indicative of wakeup signal transmission times based on a wakeup schedule of a station (STA) and a clock drift value for the STA and may transmit, to a primary radio of the STA, an indication of the time resolution. The AP may identify a transmission time of a wakeup signal for the STA and determine a value indicative of the transmission time. The AP may transmit, to a wakeup radio of the STA, the wakeup signal as a packet that includes the value indicative of the transmission time. The STA may determine the transmission time of the wakeup signal based on the wakeup schedule, the indication of the time resolution, and the value indicative of the transmission time and may update a local clock timing based on the transmission time.

### CROSS REFERENCES

The present Application for Patent claims priority to U.S. Provisional Patent Application No. 62/482,122 by Shellhammer, et al., entitled “Efficient Synchronization For Wakeup Radio,” filed Apr. 5, 2017, assigned to the assignee hereof and expressly incorporated by reference herein.

### BACKGROUND

The following relates generally to wireless communication and more specifically to improved wakeup radio (WUR) synchronization techniques.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A wireless device may have a limited amount of battery power. In some cases, it may be beneficial for a primary radio (e.g., of a wireless device) to remain in a sleep mode or low power mode for extended periods of time. During a sleep mode, a wireless device may periodically activate a radio, such as a wakeup radio (which may also be referred to as a WUR or wakeup receiver), to listen for and decode a wakeup signal (e.g., wakeup transmissions) from an AP. The wireless device may then power on a primary radio of the wireless device in response to receiving the wakeup signal from the AP. In some cases, transmissions from an AP (e.g., wakeup signals) may become misaligned (e.g., in time) with periodic WUR activation intervals (e.g., WUR on periods), which may result in missed communications and increased system latency. Improved synchronization techniques to maintain timing alignment of potential incoming messages from an AP with WUR on periods at a wireless device may thus be desired.

### SUMMARY

The described techniques relate to improved methods, systems, devices, or apparatuses that support improved wakeup radio (WUR) synchronization techniques. Generally, the described techniques provide for maintaining synchronization between WUR active reception periods and transmitted WUR beacons. An access point (AP) may determine a time resolution (e.g., in microseconds, milliseconds, etc.) for values indicative of wakeup signal transmission times for one or more STAs. The AP may transmit an indication of the time resolution to the one or more STAs (e.g., over a wireless link supported by a primary radio of the STA). The AP may attempt to communicate with a given STA according to a wakeup schedule (e.g., which may be communicated to the given STA over a wireless link supported by a primary radio of the STA). However, in some cases deviations from the wakeup schedule may occur (e.g., because of a clock drift, contention-based delays, or the like). Accordingly, the AP may in some cases identify an actual transmission time of a given wakeup signal and determine a value indicative of the actual transmission time (e.g., based at least in part on the time resolution). The AP may transmit the wakeup signal as a packet that includes the value indicative of the transmission time. In some cases, the STA may update a local clock timing based at least in part on the transmission time. For example, such a communication scheme may support coordination of clock drift (e.g., which may improve timing alignment and thereby improve system throughput).

A method of wireless communication at a STA operating in a shared radio frequency spectrum band is described. The method may include receiving, using a primary radio, an indication of a time resolution for values indicative of wakeup signal transmission times, receiving, using a wakeup radio and based on a wakeup schedule of the STA, a wakeup signal as a packet that includes a value indicative of a transmission time of the wakeup signal, determining the transmission time of the wakeup signal based on the wakeup schedule, the indication of the time resolution, and the value indicative of the transmission time, and updating a local clock timing based on the transmission time.

An apparatus for wireless communication operating in a shared radio frequency spectrum band is described. The apparatus may include a processor, memory in electronic communication with the processor, and instructions stored in the memory. The instructions may be executable by the processor to cause the apparatus to receiving, using a primary radio, an indication of a time resolution for values indicative of wakeup signal transmission times, receiving, using a wakeup radio and based on a wakeup schedule of the apparatus, a wakeup signal as a packet that includes a value indicative of a transmission time of the wakeup signal, determining the transmission time of the wakeup signal based on the wakeup schedule, the indication of the time resolution, and the value indicative of the transmission time, and updating a local clock timing based on the transmission time.

Another apparatus for wireless communication operating in a shared radio frequency spectrum band is described. The apparatus may include receiving, using a primary radio, an indication of a time resolution for values indicative of wakeup signal transmission times, receiving, using a wakeup radio and based on a wakeup schedule of the apparatus, a wakeup signal as a packet that includes a value indicative of a transmission time of the wakeup signal, determining the transmission time of the wakeup signal based on the wakeup schedule, the indication of the time resolution, and the value indicative of the transmission time, and updating a local clock timing based on the transmission time.

A non-transitory computer-readable medium storing code for wireless communication operating in a shared radio frequency spectrum band is described. The code may include instructions executable by a processor to receiving, using a primary radio, an indication of a time resolution for values indicative of wakeup signal transmission times, receiving, using a wakeup radio and based on a wakeup schedule of the STA, a wakeup signal as a packet that includes a value indicative of a transmission time of the wakeup signal, determining the transmission time of the wakeup signal based on the wakeup schedule, the indication of the time resolution, and the value indicative of the transmission time, and updating a local clock timing based on the transmission time.

In some examples of the method, apparatuses, and non-transitory computer-readable medium described herein, the time resolution may be based on a clock drift value.

Some examples of the method, apparatuses, and non-transitory computer-readable medium described herein may further include operations, features, means, or instructions for receiving, using the primary radio, an indication of a maximum clock drift value, the clock drift value including the maximum clock drift value.

Some examples of the method, apparatuses, and non-transitory computer-readable medium described herein may further include operations, features, means, or instructions for determining a set of sequential time values based on the updated local clock timing and the wakeup schedule and receiving, using the wakeup radio, a second signal based on the set of sequential time values and the time resolution.

Some examples of the method, apparatuses, and non-transitory computer-readable medium described herein may further include operations, features, means, or instructions for receiving an indication of the wakeup schedule using the primary radio, where the wakeup schedule includes a set of time periods for the STA to monitor for wakeup signals.

In some examples of the method, apparatuses, and non-transitory computer-readable medium described herein, the indication of the time resolution includes a periodicity of the set of time periods.

In some examples of the method, apparatuses, and non-transitory computer-readable medium described herein, the value indicative of the transmission time includes a pattern of bits indicating a partial timing synchronization function (TSF) value for the transmission time.

Some examples of the method, apparatuses, and non-transitory computer-readable medium described herein may further include operations, features, means, or instructions for receiving, using the primary radio, an indication of a number of bits in the pattern of bits.

In some examples of the method, apparatuses, and non-transitory computer-readable medium described herein, the packet includes a first flag that indicates a presence of a field including the pattern of bits, or a second flag that indicates that the packet includes a synchronization frame, or a third flag that indicates that the packet includes a wakeup frame, or a combination thereof.

In some examples of the method, apparatuses, and non-transitory computer-readable medium described herein, the wakeup signal includes a WUR synchronization beacon or a WUR frame.

A method of wireless communication at an AP operating in a shared radio frequency spectrum band is described. The method may include determining a time resolution for values indicative of wakeup signal transmission times based on a wakeup schedule of a STA and a clock drift value for the STA, transmitting, to a primary radio of the STA, an indication of the time resolution, identifying a transmission time of a wakeup signal for the STA, determining a value indicative of the transmission time of the wakeup signal based on the transmission time and the time resolution, and transmitting, to a wakeup radio of the STA, the wakeup signal as a packet that includes the value indicative of the transmission time of the wakeup signal.

An apparatus for wireless communication operating in a shared radio frequency spectrum band is described. The apparatus may include a processor, memory in electronic communication with the processor, and instructions stored in the memory. The instructions may be executable by the processor to cause the apparatus to determining a time resolution for values indicative of wakeup signal transmission times based on a wakeup schedule of a STA and a clock drift value for the STA, transmitting, to a primary radio of the STA, an indication of the time resolution, identifying a transmission time of a wakeup signal for the STA, determining a value indicative of the transmission time of the wakeup signal based on the transmission time and the time resolution, and transmitting, to a wakeup radio of the STA, the wakeup signal as a packet that includes the value indicative of the transmission time of the wakeup signal.

Another apparatus for wireless communication operating in a shared radio frequency spectrum band is described. The apparatus may include determining a time resolution for values indicative of wakeup signal transmission times based on a wakeup schedule of a STA and a clock drift value for the STA, transmitting, to a primary radio of the STA, an indication of the time resolution, identifying a transmission time of a wakeup signal for the STA, determining a value indicative of the transmission time of the wakeup signal based on the transmission time and the time resolution, and transmitting, to a wakeup radio of the STA, the wakeup signal as a packet that includes the value indicative of the transmission time of the wakeup signal.

A non-transitory computer-readable medium storing code for wireless communication at an AP operating in a shared radio frequency spectrum band is described. The code may include instructions executable by a processor to determining a time resolution for values indicative of wakeup signal transmission times based on a wakeup schedule of a STA and a clock drift value for the STA, transmitting, to a primary radio of the STA, an indication of the time resolution, identifying a transmission time of a wakeup signal for the STA, determining a value indicative of the transmission time of the wakeup signal based on the transmission time and the time resolution, and transmitting, to a wakeup radio of the STA, the wakeup signal as a packet that includes the value indicative of the transmission time of the wakeup signal.

Some examples of the method, apparatuses, and non-transitory computer-readable medium described herein may further include operations, features, means, or instructions for transmitting, to the STA using the primary radio, an indication of a maximum clock drift value, the clock drift value including the maximum clock drift value.

Some examples of the method, apparatuses, and non-transitory computer-readable medium described herein may further include operations, features, means, or instructions for determining a set of sequential time values based on the wakeup schedule and the transmission time and transmitting a second signal to the wakeup radio of the STA based on a next time value of the set of sequential time values.

Some examples of the method, apparatuses, and non-transitory computer-readable medium described herein may further include operations, features, means, or instructions for transmitting the wakeup schedule to the primary radio of the STA, where the wakeup schedule includes a set of time periods for the STA to monitor for signals from the AP.

In some examples of the method, apparatuses, and non-transitory computer-readable medium described herein, the indication of the time resolution includes a periodicity of the set of time periods.

In some examples of the method, apparatuses, and non-transitory computer-readable medium described herein, the value indicative of the transmission time includes a pattern of bits indicating a partial TSF value associated with the transmission time.

Some examples of the method, apparatuses, and non-transitory computer-readable medium described herein may further include operations, features, means, or instructions for transmitting, to the primary radio of the STA, an indication of a number of bits in the pattern of bits.

A method of wireless communication is described. The method may include identifying an actual transmission time for a signal, determining a time difference between the actual transmission time and a scheduled transmission time for the signal, wherein the time difference is based at least in part a delay in accessing the shared radio frequency spectrum band or a delay resulting from a different scheduled transmission, and transmitting the signal as a packet that comprises a value indicative of the time difference between the actual transmission time and the scheduled transmission time.

An apparatus for wireless communication is described. The apparatus may include means for identifying an actual transmission time for a signal, means for determining a time difference between the actual transmission time and a scheduled transmission time for the signal, wherein the time difference is based at least in part a delay in accessing the shared radio frequency spectrum band or a delay resulting from a different scheduled transmission, and means for transmitting the signal as a packet that comprises a value indicative of the time difference between the actual transmission time and the scheduled transmission time.

Another apparatus for wireless communication is described. The apparatus may include a processor, memory in electronic communication with the processor, and instructions stored in the memory. The instructions may be operable to cause the processor to identify an actual transmission time for a signal, determine a time difference between the actual transmission time and a scheduled transmission time for the signal, wherein the time difference is based at least in part a delay in accessing the shared radio frequency spectrum band or a delay resulting from a different scheduled transmission, and transmit the signal as a packet that comprises a value indicative of the time difference between the actual transmission time and the scheduled transmission time.

A non-transitory computer readable medium for wireless communication is described. The non-transitory computer-readable medium may include instructions operable to cause a processor to identify an actual transmission time for a signal, determine a time difference between the actual transmission time and a scheduled transmission time for the signal, wherein the time difference is based at least in part a delay in accessing the shared radio frequency spectrum band or a delay resulting from a different scheduled transmission, and transmit the signal as a packet that comprises a value indicative of the time difference between the actual transmission time and the scheduled transmission time.

In some examples of the method, apparatus, and non-transitory computer-readable medium described above, the time difference may be based at least in part on the delay in accessing the shared radio frequency spectrum band, and the delay comprises a delay due to a carrier sense operation. In some examples of the method, apparatus, and non-transitory computer-readable medium described above, the time difference may be based at least in part on the delay resulting from a different scheduled transmission.

Some examples of the method, apparatus, and non-transitory computer-readable medium described above may further include processes, features, means, or instructions for transmitting a subsequent packet after transmitting the packet, wherein the subsequent packet may be transmitted based at least in part on the scheduled transmission time.

Some examples of the method, apparatus, and non-transitory computer-readable medium described above may further include processes, features, means, or instructions for transmitting a prior packet before transmitting the packet, wherein the prior packet may be transmitted based at least in part on the scheduled transmission time.

In some examples of the method, apparatus, and non-transitory computer-readable medium described above, the signal comprises a WUR synchronization beacon. In some examples of the method, apparatus, and non-transitory computer-readable medium described above, the signal comprises a WUR wakeup frame. In some examples of the method, apparatus, and non-transitory computer-readable medium described above, the signal comprises a periodic signal or an aperiodic signal. In some examples of the method, apparatus, and non-transitory computer-readable medium described above, the value indicative of the time difference between the actual transmission time and the scheduled transmission time comprises a field within the packet. In some examples of the method, apparatus, and non-transitory computer-readable medium described above, the packet comprises a flag that indicates a presence of the field. In some examples of the method, apparatus, and non-transitory computer-readable medium described above, the packet comprises a frame control field, and wherein the flag comprise one or more bits of the frame control field.

In some examples of the method, apparatus, and non-transitory computer-readable medium described above, the field comprises a pattern of bits indicative of the time difference between the actual transmission time and the scheduled transmission time. In some examples of the method, apparatus, and non-transitory computer-readable medium described above, the pattern of bits comprises two octets. In some examples of the method, apparatus, and non-transitory computer-readable medium described above, the pattern of bits comprises one octet. In some examples of the method, apparatus, and non-transitory computer-readable medium described above, the pattern of bits indicates that the time difference between the actual transmission time and the scheduled transmission time may be greater than a threshold.

In some examples of the method, apparatus, and non-transitory computer-readable medium described above, the packet comprises at least one of a physical layer header, a frame control field, a receiver identifier filed, a transmitter identifier field, a frame body field, or cyclic redundancy check (CRC) field, or any combination thereof. In some examples of the method, apparatus, and non-transitory computer-readable medium described above, the packet comprises a flag that indicates that the packet comprises a synchronization frame or a wakeup frame.

A method of wireless communication is described. The method may include receiving a signal as a packet that comprises a value indicative of a time difference between an actual transmission time and a scheduled transmission time, wherein the time difference is based at least in part a delay in accessing the shared radio frequency spectrum band or a delay resulting from a different scheduled transmission, determining a time period to monitor for a subsequent signal based at least in part on the scheduled transmission time and the value indicative of a time difference between the actual transmission time and the scheduled transmission time, and monitoring for the subsequent signal during the time period based at least in part on the determining.

An apparatus for wireless communication is described. The apparatus may include means for receiving a signal as a packet that comprises a value indicative of a time difference between an actual transmission time and a scheduled transmission time, wherein the time difference is based at least in part a delay in accessing the shared radio frequency spectrum band or a delay resulting from a different scheduled transmission, means for determining a time period to monitor for a subsequent signal based at least in part on the scheduled transmission time and the value indicative of a time difference between the actual transmission time and the scheduled transmission time, and means for monitoring for the subsequent signal during the time period based at least in part on the determining.

Another apparatus for wireless communication is described. The apparatus may include a processor, memory in electronic communication with the processor, and instructions stored in the memory. The instructions may be operable to cause the processor to receive a signal as a packet that comprises a value indicative of a time difference between an actual transmission time and a scheduled transmission time, wherein the time difference is based at least in part a delay in accessing the shared radio frequency spectrum band or a delay resulting from a different scheduled transmission, determine a time period to monitor for a subsequent signal based at least in part on the scheduled transmission time and the value indicative of a time difference between the actual transmission time and the scheduled transmission time, and monitor for the subsequent signal during the time period based at least in part on the determining.

A non-transitory computer readable medium for wireless communication is described. The non-transitory computer-readable medium may include instructions operable to cause a processor to receive a signal as a packet that comprises a value indicative of a time difference between an actual transmission time and a scheduled transmission time, wherein the time difference is based at least in part a delay in accessing the shared radio frequency spectrum band or a delay resulting from a different scheduled transmission, determine a time period to monitor for a subsequent signal based at least in part on the scheduled transmission time and the value indicative of a time difference between the actual transmission time and the scheduled transmission time, and monitor for the subsequent signal during the time period based at least in part on the determining.

In some examples of the method, apparatus, and non-transitory computer-readable medium described above, the time difference may be based at least in part on the delay in accessing the shared radio frequency spectrum band, and the delay comprises a delay due to a carrier sense operation. In some examples of the method, apparatus, and non-transitory computer-readable medium described above, the time difference may be based at least in part on the delay resulting from a different scheduled transmission.

Some examples of the method, apparatus, and non-transitory computer-readable medium described above may further include processes, features, means, or instructions for receiving a prior packet before receiving the packet. Some examples of the method, apparatus, and non-transitory computer-readable medium described above may further include processes, features, means, or instructions for determining the scheduled transmission time based at least in part on another value indicated in the prior packet.

In some examples of the method, apparatus, and non-transitory computer-readable medium described above, the signal comprises a WUR synchronization beacon. In some examples of the method, apparatus, and non-transitory computer-readable medium described above, the signal comprises a WUR wakeup frame. In some examples of the method, apparatus, and non-transitory computer-readable medium described above, the signal comprises a periodic signal or an aperiodic signal. In some examples of the method, apparatus, and non-transitory computer-readable medium described above, the value indicative of the time difference between the actual transmission time and the scheduled transmission time comprises a field within the packet. In some examples of the method, apparatus, and non-transitory computer-readable medium described above, the packet comprises a flag that indicates a presence of the field.

In some examples of the method, apparatus, and non-transitory computer-readable medium described above, the packet comprises a frame control field, and wherein the flag comprise one or more bits of the frame control field. In some examples of the method, apparatus, and non-transitory computer-readable medium described above, the field comprises a pattern of bits indicative of the time difference between the actual transmission time and the scheduled transmission time. In some examples of the method, apparatus, and non-transitory computer-readable medium described above, the pattern of bits comprises two octets. In some examples of the method, apparatus, and non-transitory computer-readable medium described above, the pattern of bits comprises one octet. In some examples of the method, apparatus, and non-transitory computer-readable medium described above, the pattern of bits indicates that the time difference between the actual transmission time and the scheduled transmission time may be greater than a threshold.

In some examples of the method, apparatus, and non-transitory computer-readable medium described above, the packet comprises at least one of a physical layer header, a frame control field, a receiver identifier filed, a transmitter identifier field, a frame body field, or CRC field, or any combination thereof.

In some examples of the method, apparatus, and non-transitory computer-readable medium described above, the packet comprises a flag that indicates that the packet comprises a synchronization frame or a wakeup frame.

A method of wireless communication is described. The method may include determining a time resolution based at least in part on a clock drift for one or more STAs, determining a transmission time for a signal, and transmitting the signal as a packet that comprises a value indicative of the transmission time and based at least in part on the time resolution.

An apparatus for wireless communication is described. The apparatus may include means for determining a time resolution based at least in part on a clock drift for one or more STAs, means for determining a transmission time for a signal, and means for transmitting the signal as a packet that comprises a value indicative of the transmission time and based at least in part on the time resolution.

Another apparatus for wireless communication is described. The apparatus may include a processor, memory in electronic communication with the processor, and instructions stored in the memory. The instructions may be operable to cause the processor to determine a time resolution based at least in part on a clock drift for one or more STAs, determine a transmission time for a signal, and transmit the signal as a packet that comprises a value indicative of the transmission time and based at least in part on the time resolution.

A non-transitory computer readable medium for wireless communication is described. The non-transitory computer-readable medium may include instructions operable to cause a processor to determine a time resolution based at least in part on a clock drift for one or more STAs, determine a transmission time for a signal, and transmit the signal as a packet that comprises a value indicative of the transmission time and based at least in part on the time resolution.

Some examples of the method, apparatus, and non-transitory computer-readable medium described above may further include processes, features, means, or instructions for determining a set of sequential time values based at least in part on the transmission time. Some examples of the method, apparatus, and non-transitory computer-readable medium described above may further include processes, features, means, or instructions for transmitting a second signal based at least in part on a next time value of the set that follows the transmission time for the signal.

Some examples of the method, apparatus, and non-transitory computer-readable medium described above may further include processes, features, means, or instructions for determining the time resolution based at least in part on a message exchange with the one or more STAs prior to transmitting the signal.

In some examples of the method, apparatus, and non-transitory computer-readable medium described above, the message exchange may be performed using a first radio of the one or more STAs. In some examples of the method, apparatus, and non-transitory computer-readable medium described above, the transmissions associated with the first radio comprise a higher bit rate than transmissions associated with the transmitted signal.

In some examples of the method, apparatus, and non-transitory computer-readable medium described above, the value indicative of the transmission time comprises a field within the packet. In some examples of the method, apparatus, and non-transitory computer-readable medium described above, the packet comprises a flag that indicates a presence of the field. In some examples of the method, apparatus, and non-transitory computer-readable medium described above, the packet comprises a frame control field, and wherein the flag comprise one or more bits of the frame control field. In some examples of the method, apparatus, and non-transitory computer-readable medium described above, the field comprises a pattern of bits indicative of the transmission time. In some examples of the method, apparatus, and non-transitory computer-readable medium described above, the pattern of bits comprises two octets. In some examples of the method, apparatus, and non-transitory computer-readable medium described above, the pattern of bits comprises one octet. In some examples of the method, apparatus, and non-transitory computer-readable medium described above, the pattern of bits indicates a partial TSF value associated with the transmission time.

In some examples of the method, apparatus, and non-transitory computer-readable medium described above, the packet further indicates the time resolution. In some examples of the method, apparatus, and non-transitory computer-readable medium described above, the time resolution may be based at least in part on a maximum clock drift value.

In some examples of the method, apparatus, and non-transitory computer-readable medium described above, the packet comprises at least one of a physical layer header, a frame control field, a receiver identifier filed, a transmitter identifier field, a frame body field, or CRC field, or any combination thereof.

In some examples of the method, apparatus, and non-transitory computer-readable medium described above, the packet comprises a flag that indicates that the packet comprises a synchronization frame or a wakeup frame. In some examples of the method, apparatus, and non-transitory computer-readable medium described above, the signal comprises a WUR synchronization beacon. In some examples of the method, apparatus, and non-transitory computer-readable medium described above, the signal comprises a WUR wakeup frame. In some examples of the method, apparatus, and non-transitory computer-readable medium described above, the signal comprises a periodic signal or an aperiodic signal.

A method of wireless communication is described. The method may include receiving a signal as a packet that comprises a first value indicative of an actual transmission time, determining a time resolution of the first value, and setting a clock timing based at least in part on a local clock value, the received first value, and the determined time resolution.

An apparatus for wireless communication is described. The apparatus may include means for receiving a signal as a packet that comprises a first value indicative of an actual transmission time, means for determining a time resolution of the first value, and means for setting a clock timing based at least in part on a local clock value, the received first value, and the determined time resolution.

Another apparatus for wireless communication is described. The apparatus may include a processor, memory in electronic communication with the processor, and instructions stored in the memory. The instructions may be operable to cause the processor to receive a signal as a packet that comprises a first value indicative of an actual transmission time, determine a time resolution of the first value, and set a clock timing based at least in part on a local clock value, the received first value, and the determined time resolution.

A non-transitory computer readable medium for wireless communication is described. The non-transitory computer-readable medium may include instructions operable to cause a processor to receive a signal as a packet that comprises a first value indicative of an actual transmission time, determine a time resolution of the first value, and set a clock timing based at least in part on a local clock value, the received first value, and the determined time resolution.

In some examples of the method, apparatus, and non-transitory computer-readable medium described above, setting the clock timing comprises: determining an updated value of the local clock based at least in part on the received first value and the determined time resolution. Some examples of the method, apparatus, and non-transitory computer-readable medium described above may further include processes, features, means, or instructions for determining a set of sequential time values based on the updated value. Some examples of the method, apparatus, and non-transitory computer-readable medium described above may further include processes, features, means, or instructions for setting the clock timing to one of the time values of the set based at least in part on the local clock value.

In some examples of the method, apparatus, and non-transitory computer-readable medium described above, the packet comprises at least one of a physical layer header, a frame control field, a receiver identifier filed, a transmitter identifier field, a frame body field, or CRC field, or any combination thereof.

In some examples of the method, apparatus, and non-transitory computer-readable medium described above, the packet comprises a flag that indicates that the packet comprises a synchronization frame or a wakeup frame. Some examples of the method, apparatus, and non-transitory computer-readable medium described above may further include processes, features, means, or instructions for monitoring for a subsequent signal based at least in part on the set clock timing. In some examples of the method, apparatus, and non-transitory computer-readable medium described above, the first value indicative of the transmission time comprises a field within the packet.

In some examples of the method, apparatus, and non-transitory computer-readable medium described above, the packet comprises a flag that indicates a presence of the field. In some examples of the method, apparatus, and non-transitory computer-readable medium described above, the packet comprises a frame control field, and wherein the flag comprises one or more bits of the frame control field. In some examples of the method, apparatus, and non-transitory computer-readable medium described above, the field comprises a pattern of bits indicative of the transmission time. In some examples of the method, apparatus, and non-transitory computer-readable medium described above, the pattern of bits comprises one octet.

In some examples of the method, apparatus, and non-transitory computer-readable medium described above, the pattern of bits indicates a partial TSF value associated with the transmission. In some examples of the method, apparatus, and non-transitory computer-readable medium described above, the packet further indicates the time resolution. In some examples of the method, apparatus, and non-transitory computer-readable medium described above, the resolution may be based at least in part on a maximum clock drift value. In some examples of the method, apparatus, and non-transitory computer-readable medium described above, the time resolution may be determined based at least in part on a message exchange with an access point prior to receiving the signal.

In some examples of the method, apparatus, and non-transitory computer-readable medium described above, the message exchange may be performed using a first radio and the signal may be received using a second radio. In some examples of the method, apparatus, and non-transitory computer-readable medium described above, the message exchange performed using the first radio comprises a higher bit rate than the signal associated with the second radio.

In some examples of the method, apparatus, and non-transitory computer-readable medium described above, the signal comprises a WUR synchronization beacon. In some examples of the method, apparatus, and non-transitory computer-readable medium described above, the signal comprises a WUR wakeup frame. In some examples of the method, apparatus, and non-transitory computer-readable medium described above, the signal comprises a periodic signal or an aperiodic signal.

### BRIEF DESCRIPTION OF THE DRAWINGS

FIG. 1 illustrates an example of a wireless local area network (WLAN) that supports improved wakeup radio (WUR) synchronization techniques in accordance with aspects of the present disclosure.

FIG. 2 illustrates an example of a wireless communications system that supports improved WUR synchronization techniques in accordance with aspects of the present disclosure.

FIGS. 3 and 4 illustrate examples of synchronization timelines that support improved WUR synchronization techniques in accordance with aspects of the present disclosure.

FIG. 5 illustrates examples of WUR frames that supports improved WUR synchronization techniques in accordance with aspects of the present disclosure.

FIGS. 6 and 7 illustrate example process flows that supports improved WUR synchronization techniques in accordance with aspects of the present disclosure.

FIGS. 8 through 10 show block diagrams of a device that supports improved WUR synchronization techniques in accordance with aspects of the present disclosure.

FIG. 11 illustrates a block diagram of a system including an AP that supports improved WUR synchronization techniques in accordance with aspects of the present disclosure.

FIGS. 12 through 14 show block diagrams of a device that supports improved WUR synchronization techniques in accordance with aspects of the present disclosure.

FIG. 15 illustrates a block diagram of a system including a STA that supports improved WUR synchronization techniques in accordance with aspects of the present disclosure.

FIGS. 16 through 23 illustrate methods for improved WUR synchronization techniques in accordance with aspects of the present disclosure.

### DETAILED DESCRIPTION

An access point (AP) may transmit a packet that includes an indication of a time difference between an actual transmission time and a scheduled transmission time. For example, the AP may transmit information that a station (STA) can use to determine a time difference between an actual transmission time and a scheduled transmission time. The STA may use the indication of the time difference to determine when to monitor for subsequent transmissions, to adjust clock timing, and the like. Such techniques may mitigate or reduce the likelihood of missed transmissions or unnecessary monitoring periods.

By way of example, delays in WUR beacon transmission (e.g., due to carrier sensing, etc.) may result in a loss of synchronization between the STA and the AP. In some examples, WUR activation periods may be large enough (e.g., long enough in duration) to account for small delays in beacon transmission. However, a WUR STA that misses one or more WUR beacons may not receive subsequent WUR beacons within a maximum delay margin of error associated with WUR active states, resulting in loss of synchronization. Such scenarios may arise from accumulated delays (e.g., from beacon schedules shifting after each delayed beacon transmission) that are unaccounted for by the WUR STA.

Therefore, a STA may power up a WUR (e.g., a companion radio) during power on periods (e.g., service periods) according to a duty-cycle that may be synchronized with the periodically transmitted WUR beacons. Synchronization techniques (e.g., clock timing adjustments, duty-cycle adjustments, or the like) may account for WUR beacon delays to avoid loss of synchronization. According to techniques described herein, APs may include timing information with WUR beacons to maintain synchronization, even in cases where WUR beacons are delayed by AP and/or missed by the STA. The timing information may indicate the amount of time by which the WUR beacon was delayed from the scheduled transmission time, such that the STA may, for example, adjust an expected time for a subsequent WUR beacon based on the delay. In some cases, timing information included in WUR beacons may indicate partial clock information (e.g., partial timing synchronization function (TSF) information) associated with the AP at the time of transmission. The STA may receive a delayed WUR beacon and, according to the received timing information, adjust a reference point and/or an expected sequence or schedule of subsequent WUR beacons, thus accounting for beacon delays and maintaining WUR synchronization with the AP.

Aspects of the disclosure are initially described in the context of a wireless communications system. Example synchronization timelines, formats of WUR frames, and process flows employing techniques discussed herein are then described. Aspects of the disclosure are further illustrated by and described with reference to apparatus diagrams, system diagrams, and flowcharts that relate to improved WUR synchronization techniques.

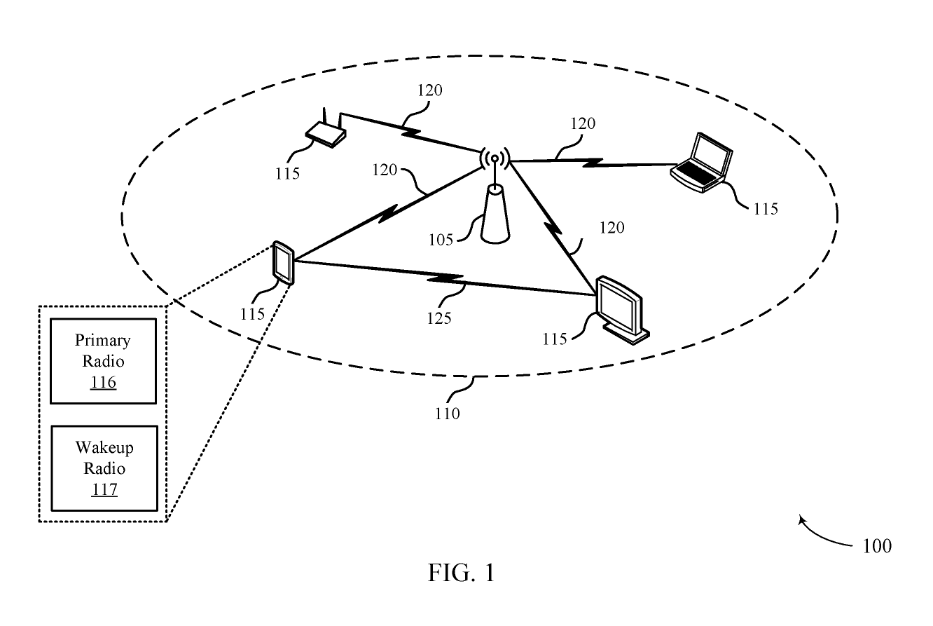

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as wireless communication terminals, including mobile stations, phones personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. WLAN 100 may support media access control for wakeup radio.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc.

In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands, such as shared licensed frequency bands, where multiple operators may have a license to operate in the same or overlapping frequency band or bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier-sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

A STA 115 may include a primary radio 116 and a wakeup radio (WUR) 117 (e.g., a low-power radio, low-power wakeup radio, etc.,) for communication. The primary radio 116 (which may also be or be referred to as a main radio) may be used during active modes (e.g., full power modes) or for high-data throughput applications. The wakeup radio 117 may be used during low-power modes or for low-throughput applications. In some examples, the wakeup radio 117 may be referred to as a companion radio, a companion wakeup radio, or a wakeup receiver radio.

A STA 115 may listen using a WUR, such as wakeup radio 117, for a wakeup message or wakeup frame in a wakeup waveform. In some cases, STA 115 may receive a preamble having a first bandwidth (e.g., a wideband signal, such as on a 20 MHz channel) and a wakeup signal (e.g., a WUR signal) having a second bandwidth (e.g., a narrowband signal, such as a 4-5 MHz channel within the 20 MHz channel). Further, the wakeup radio 117 may share the same medium (e.g., frequency spectrum targeted for reception) as primary radio 116. However, transmissions intended for wakeup radio 117 may be associated with lower data rates (e.g., tens or hundreds of kbps).

As discussed above, APs 105 may delay transmissions to a STA 115 due to, for example, CSMA/CA. In some cases, WUR beacons transmitted by AP 105 may be delayed such that a WUR (e.g., a wakeup radio 117 of a STA 115) may lose synchronization with the AP 105, resulting in decreased system performance. Therefore, an AP 105 may transmit partial TSF information or delta (e.g., delay) information along with WUR beacons enabling improved synchronization techniques between APs 105 and STAs 115. Techniques described herein are discussed with reference to WUR beacons, synchronization frames, etc. but may apply to any repeated (e.g., periodic or quasi-periodic) transmissions expected according to some predetermined or agreed upon scheduling without departing from the scope of the present disclosure.

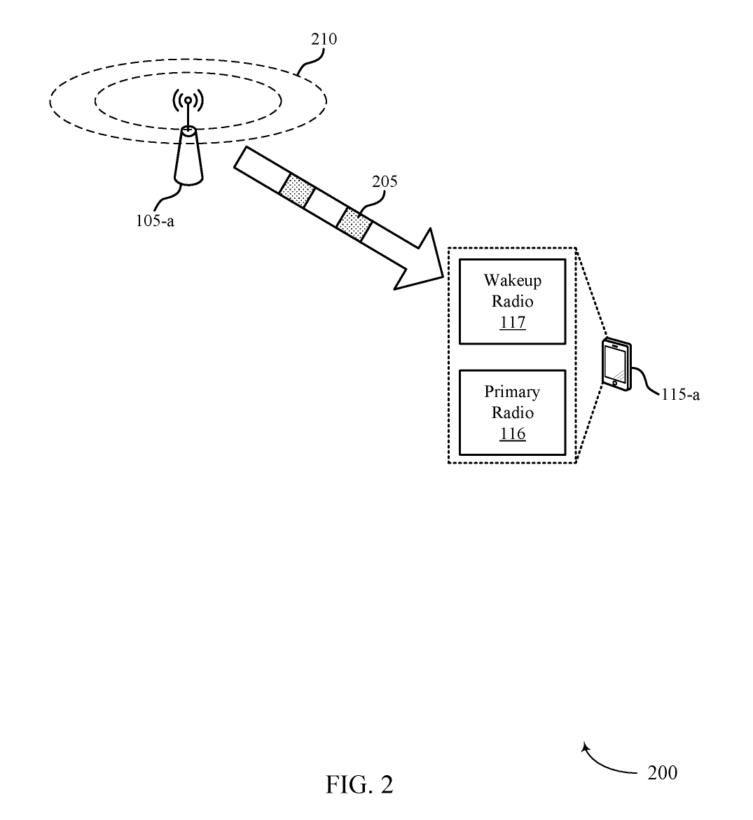

FIG. 2 illustrates an example of a wireless communications system 200 that supports improved WUR synchronization techniques in accordance with various aspects of the present disclosure. In some examples, wireless communications system 200 may implement aspects of WLAN 100. Wireless communications system 200 may include an AP 105-a and a STA 115-a which may be examples of the corresponding devices described with reference to FIG. 1. STA 115-a may include a primary radio 116 and a wakeup radio 117 (e.g., a WUR) for communication.

The primary radio 116 may be used during active modes or for high-data throughput applications (e.g., for full power transmissions from AP 105-a). The low-power wakeup radio 117 may be used during low-power modes or for low-throughput applications (e.g., for wakeup transmissions from AP 105-a). A STA 115 may receive wakeup transmissions and power additional circuitry (e.g., primary radio 116). In some examples, the low-power wakeup radio 117 may be a WUR. The wakeup radio 117 may listen for wakeup transmissions (e.g., WUR beacons 205, WUR transmissions, etc.) and wakeup the primary radio 116 of STA 115-a for primary communications (e.g., full power, high-data throughput applications).

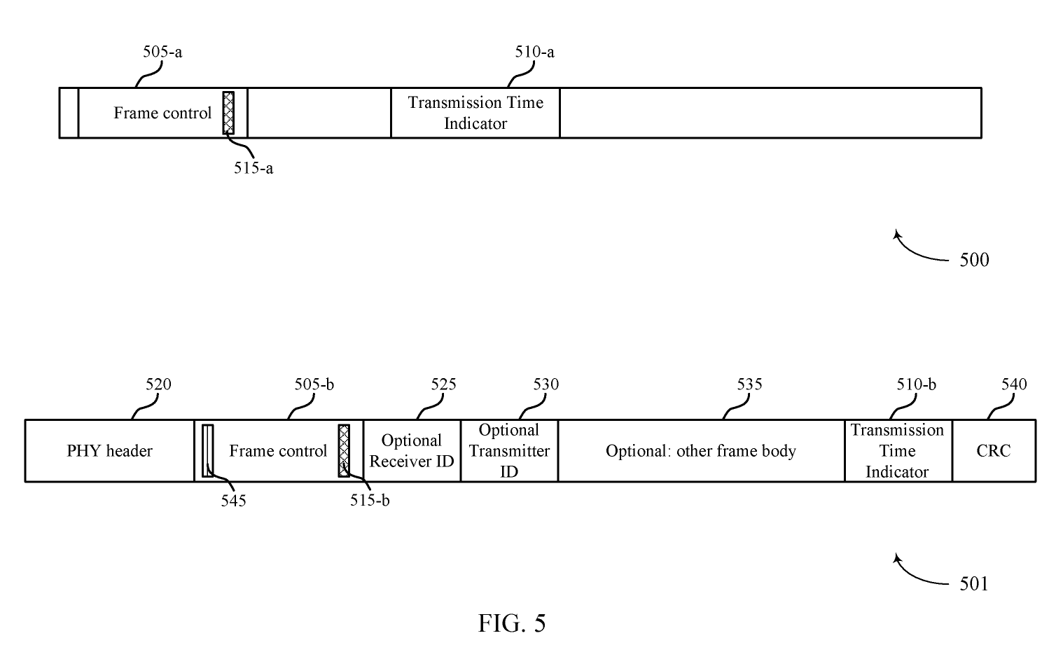

AP 105-a may transmit periodic WUR beacons 205 to STA 115-a. STA 115-a may power a WUR (e.g., wakeup radio 117) during power on periods (e.g., service periods) according to a duty-cycle synchronized with periodically transmitted WUR beacons 205. In some cases, transmission of a WUR beacon 205 may be delayed, for example, due to contention procedures 210 (e.g., CSMA/CA) performed by AP 105-a. Synchronization techniques (e.g., clock timing adjustments) may need to account for WUR beacon delays to avoid losing synchronization. According to techniques described herein, AP 105-a may include timing information with WUR beacons 205 to maintain synchronization, even in cases where WUR beacons 205 are delayed by AP 105-a and/or missed by STA 115-a. The timing information included with a WUR beacon 205 may indicate the amount of time transmission of the WUR beacon 205 was delayed from the scheduled transmission time or partial clock information (e.g., partial timing synchronization function (TSF) information) associated with the AP, as further described with reference to FIG. 5. STA 115-a may receive a delayed WUR beacon 205 and, according to the received timing information, appropriately account for subsequent WUR beacons 205, thus maintaining synchronization with AP 105-a.

A WUR (e.g., wakeup radio 117) of STA 115-a may operate according to a duty-cycle to save power. STA 115-a may thus maintain synchronization with AP 105-a to turn on the WUR for potential incoming messages (e.g., to align the WUR duty-cycle with transmissions from AP 105-a). In some cases, AP 105-a may send TSF information of a main radio to the STA 115-a. That is, a beacon transmitted by AP 105-a may carry timing information bits (e.g., 8 bytes of information) associated with the clock of AP 105-a. The timing information may represent a clock value at the time the beacon was transmitted, such that STA 115-a may maintain synchronization with AP 105-a. However, such information (e.g., TSF information) may be too large or too many bytes of data for wakeup radio 117 utilized by STA 115-a. In such cases, synchronization techniques may utilize timing information relating to the time a beacon transmission is delayed relative to a scheduled transmission time to reduce overhead associated with WUR transmissions (e.g., WUR beacons 205) and thus improve wireless communications system 200 synchronization and performance.

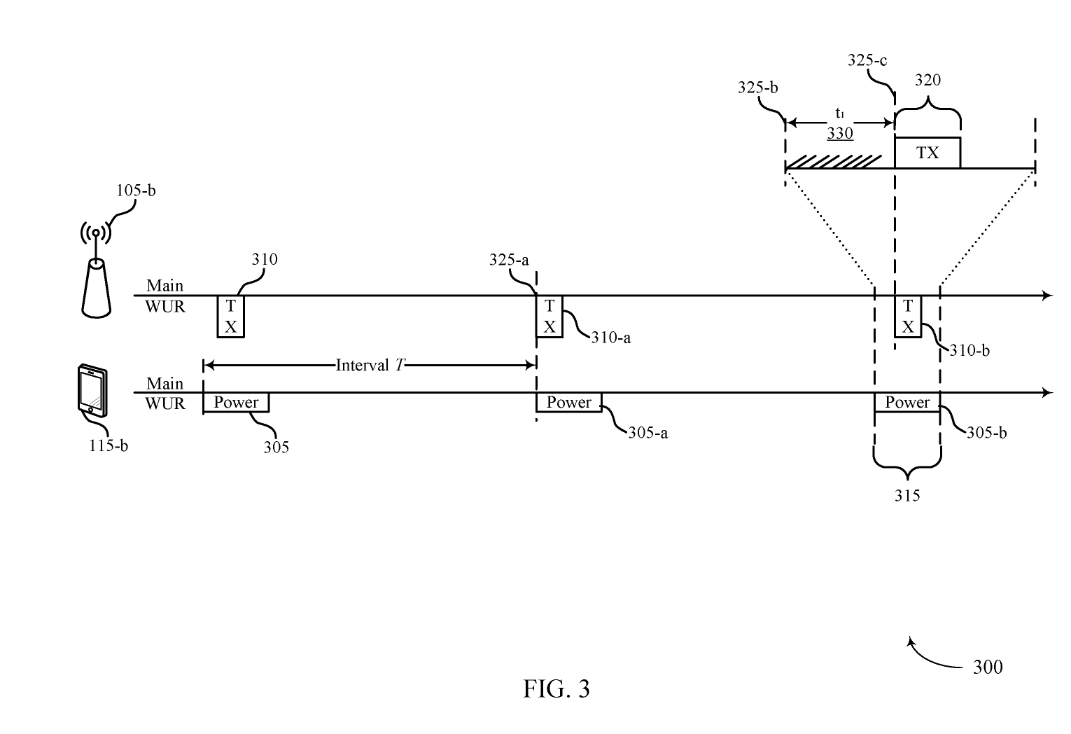

FIG. 3 illustrates an example of a synchronization timeline 300 that supports improved WUR synchronization techniques in accordance with various aspects of the present disclosure. In some examples, synchronization timeline 300 may implement aspects of WLAN 100. Synchronization timeline 300 may include AP 105-b and STA 115-b, which may represent aspects of a STA 115 or AP 105 as described with reference to FIGS. 1 and 2. In some cases, synchronization timeline 300 may refer to transmission and reception of WUR beacons 205 described with reference to FIG. 2.

STA 115-b may power a WUR according to a duty-cycle. That is, the WUR of STA 115-b may enter a power on state 305 (e.g., a service period) periodically according to a time interval T. Every T ms, the WUR of STA 115-b may enter a power on state 305 to monitor for transmissions 310 (e.g., synchronization frames or WUR beacons) from AP 105-b. AP 105-b may announce a schedule (e.g., defining scheduled times 325) when the AP 105-b will send synchronization frames (e.g., transmissions 310). The schedule may be based on a reference point in time, such as a TSF timer of the main radio associated with AP 105-b. STA 115-b may active its WUR according to the duty-cycle to receive some or all of the synchronization frames based on the schedule from AP 105-b. As described below, an AP 105 may transmit full or partial TSF timer information or transmission delay information along with transmissions 310 to maintain synchronization. STA 115-b may adjust its clock based on the arrival timing of transmissions 310 and the delay information, or based on TSF timer information (e.g., for a rough estimate of the AP 105-b clock).

AP 105-b may send transmissions 310 during STA 115-b power on states 305 according to a wakeup schedule. For example, AP 105-b may announce a schedule for WUR transmissions (e.g., via a primary radio). In the present example, WUR transmissions are sent every T ms, however, techniques described herein may apply to any repeated (e.g., periodic or quasi-periodic) transmissions expected according to some predetermined or agreed upon scheduling. In some cases, a transmission may be sent according to a schedule. For example, transmission 310-a may be scheduled to occur at a scheduled time 325-a, and the beginning of power on state 305-a may align with the transmission 310-a at the scheduled time 325-a. However, in some cases, transmissions 310 may be delayed relative to scheduled times 325.

Within some offset or margin of error (e.g., maximum delay), a power on state 305 may be long enough to account for potential delays associated with transmissions 310. Each power on state 305 may last an active duration 315. Active durations 315 associated with power on states 305 may be large enough to receive a transmission 310 over a transmission duration 320, while reserving time for potential delay durations 330 (e.g., t₁). For example, a transmission 310 from AP 105-b (e.g., a WUR beacon 205) may be delayed for a delay duration 330 (e.g., t₁=4 to 8 ms) due to CSMA/CA procedures performed by AP 105-b. That is, transmission 310-b may be scheduled to occur at a scheduled time 325-b. However, due to, for example, a CSMA/CA procedure that determines there is contention over the air at scheduled time 325-b, transmission 310-b may be delayed for a delay duration 330 beyond scheduled time 325-b. STA 115-b may thus receive transmissions 310 according to predetermined times or scheduled times 325 as long as delay durations 330 associated with the transmissions 310 do not exceed some maximum delay (e.g., t₁<8 ms).

In some cases, delay durations 330 may exceed a maximum delay that can be accounted for by STA 115-b scheduled power on states 305 (e.g., due to loss of synchronization). For example, AP 105-b and STA 115-b may lose synchronization with each other due to drifting clocks (e.g., STA 115-b may miss one or more transmissions 310, which may contain AP 105-b clock information, and may become unsynchronized from AP 105-b due to compounding delays resulting from the multiple missed transmissions).

To reduce loss of synchronization issues, AP 105-b may include delta (e.g., transmission delay) timing information in transmissions 310, while maintaining a static predetermined set of scheduled times 325 (e.g., not shifting or updating a schedule due to delays in some transmissions). Delta timing information (e.g., delay duration 330 or t₁) may be included in transmissions 310 such that a WUR or STA 115 that receives the transmission 310 may determine the subsequent transmission 310 may arrive earlier than expected (e.g., may derive corrected timing of (T−t₁) ms for the next transmission 310). A WUR or STA 115 that misses the transmission 310 may still expect the subsequent transmission 310 to arrive around T ms from the time of the missed transmission 310.

Additionally or alternatively, transmissions 310 may include a partial TSF field that includes partial TSF information associated with the timing of a transmission 310. The partial TSF field may be implemented with existing hardware (e.g., the 6th through 13th least significant bits, or one octet, of TSF timer information may be included in the TSF field for 32 us resolution). If the delay duration 330 overflows the delta field, the field may be set to all ones (e.g., ‘1’). If partial TSF information happens to be all ones, the least significant bit may be toggled to 0 to indicate the information is associated with the TSF timer of the AP 105-b. The partial TSF information field (Tₚ) may, in some examples, be determined as follows, where Tₛ is the scheduled beacon time (e.g., scheduled times 325).
If Tₚ is not present: update TSF to Tₛ;
If Tₚ has all 1's in it: do not update TSF
Else: replace corresponding bits in Tₛ with Tₚ to get Tₙ
If Tₙ<Tₛ: Tₙ=Tₙ+2^{BitLength}(Tₚ)
Update TSF to Tₙ
   A determination of Tₙ may occur or depend on whether the delta (e.g., delay duration 330) causes carrier update.

For example, AP 105-b may include partial TSF timing information in transmissions 310 so as to update (e.g., dynamically) a set of scheduled times 325. A WUR of STA 115-b that receives the transmission 310 may determine timing of subsequent transmissions 310 based on the partial TSF timing information. That is, STA 115-b may update a local clock value based on the partial TSF information thus determining a reference point in time. The STA 115 may then determine a set of sequential time values for subsequent transmissions 310 based on the reference point (e.g., the STA may derive a sequence of points occurring every T ms for subsequent transmissions 310 from the reference point).

The partial TSF information may be sent according to a time resolution that is based on a maximum clock drift value between the STA 115 and the AP 105. In some cases, the time resolution may be determined via a message exchange (e.g., negotiation procedure, handshaking, etc.) prior to the transmission of the transmission 310. The message exchange may occur via the main radio of the STA. That is, AP 105-b and STA 115-b may agree on a maximum clock drift (e.g., through some predetermine or configured requirement).

In such examples where the AP 105-b transmits partial TSF information, the AP 105-b may not record or keep track of the timing delay (e.g., between the previously scheduled transmission time and the actual transmission time). The AP 105-b may copy part of its TSF (e.g., the partial TSF information) into the transmission 310. The time resolution of the partial TSF field may avoid any ambiguity caused by clock drift discussed above. For example, transmission 310-b may include partial TSF information associated with the clock value of AP 105-b at time 325-c (e.g., TSF1 [7,14], covering 16 ms range and a 64 μs resolution). In this notation, TSF1 [7,14] may represent the eighth through fifteenth bits of a TSF timer (e.g., a least significant octet of bits). Though described in the context of an octet, it is to be understood that any suitable number of bits may be included in the partial TSF information. Upon reception of transmission 310-b, STA 115-b may replace its clock value (e.g., TSF1′ [7,14]) based on the received partial TSF information to obtain a new base value (e.g., reference point). STA 115-b may choose a value from the set [BASE+/−n*16384 μs] that is closest to TSF1′ and set its local clock to the selected value. For example, in a 400 parts per million (ppm) clock drift and 10 second beacon interval scenario, the difference between TSF1 and TSF1′ may be less than 4000 μs.

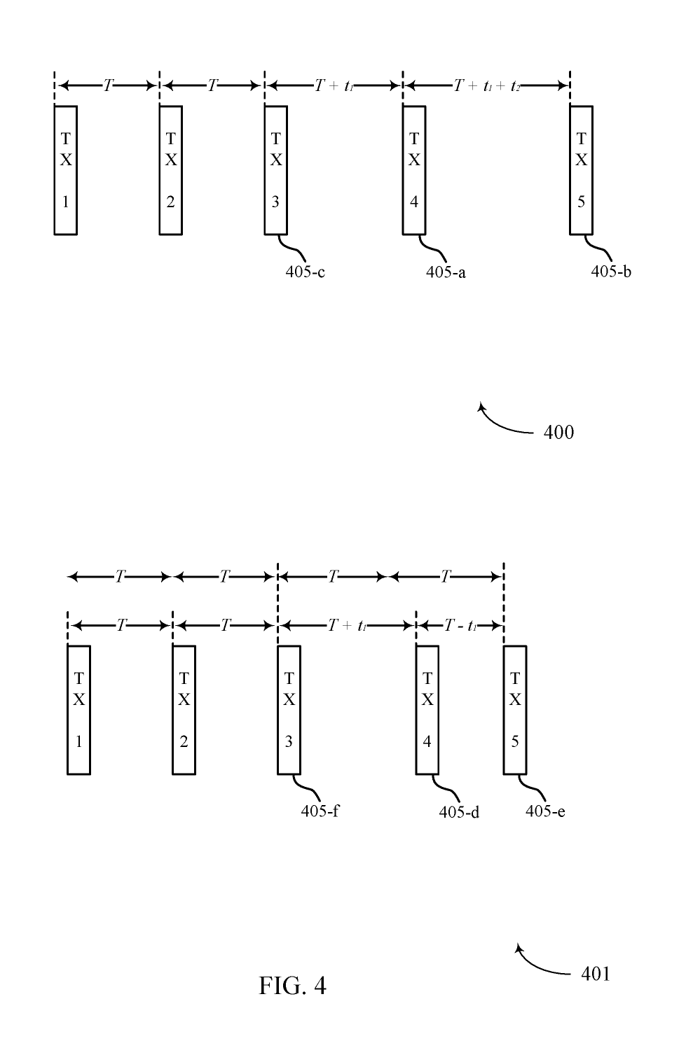

FIG. 4 illustrates an example of synchronization timelines 400 and 401 that support improved WUR synchronization techniques in accordance with various aspects of the present disclosure. In some examples, synchronization timelines 400 and 401 may implement aspects of WLAN 100. In some cases, synchronization timelines 400 and 401 may refer to transmission and reception of WUR beacons 205 and/or transmissions 310 as described with reference to FIGS. 2 and 3.

Synchronization timeline 400 illustrates a technique where the a STA 115 synchronizes on each new WUR beacon 405 (e.g., synchronization frame). In the example of synchronization timeline 400, WUR beacons 405 may carry no timing information. However, STAs 115 may receive each WUR beacon 405 and assume a subsequent WUR beacon 405 will arrive according to predefined timing (e.g., periodicity) indicated by an AP 105 (e.g., in T ms). That is, an AP 105 may transmit WUR beacons 405 T ms after delayed WUR beacons 405 (e.g., such that each delayed WUR beacon 405 is the new starting point for T). The STA 115 may look for subsequent WUR beacons 405 every T ms from a most recently received WUR beacon 405. For example, a STA 115 may receive WUR beacon 405-a at a delay t₁ from the scheduled time. The STA 115 may then expect to receive WUR beacon 405-b at a time T+t₁. WUR beacon 405-b may then be delayed a time t₂ from the expected time T+t₁. A STA 115 may thus expect subsequent WUR beacons 405 based on WUR beacon 405-b (e.g., at time T+t₁+t₂). If t₁, t₂, . . . tₙ are each less than a maximum delay a WUR active period (e.g., power on state) of a STA 115 can accommodate, the STA 115 may maintain synchronization via the WUR beacons 405.

However, if a STA 115 misses a WUR beacon 405, the clock associated with the STA 115 may drift relative to the WUR beacons 405 transmitted every T ms according to the clock of the transmitting AP 105 (e.g., due to the STA 115 not identifying CSMA/CA delays at the AP 105). For example, if a STA 115 misses WUR beacon 405-a, the STA 115 may expect WUR beacon 405-b to arrive T ms from the missed WUR beacon 405-a without accounting for the delay t₁ (e.g., 2T from a previously received WUR beacon 405-c). If t₁+t₂ is greater than the maximum delay a WUR active period of the STA 115 can accommodate, the STA 115 may fail to receive subsequent WUR beacons 405 and may lose synchronization. That is, delays may accumulate such that a STA 115 that misses one or more WUR beacons 405 may not receive subsequent WUR beacons within a maximum delay margin of error associated with WUR active states, resulting in loss of synchronization.

Synchronization timeline 401 illustrates a second technique where the STA 115 synchronizes on each new WUR beacon 405 (e.g., synchronization frame). In the example of synchronization timeline 401, WUR beacons 405 may include delta timing information (e.g., WUR beacon 405 transmission delay information such as partial TSF information). STAs 115 may assume subsequent WUR beacons 405 will arrive according to a predefined schedule announced by AP 105 (e.g., every T ms) as determined by a local clock of the STA 115. That is, an AP 105 may transmit WUR beacons 405 every T ms regardless of any delayed WUR beacons 405. For example, a STA 115 may receive WUR beacon 405-d at a delay t₁ from the scheduled time (e.g., an increment of T). The STA 115 may then expect to receive WUR beacon 405-e at a time T−t₁ from the reception of WUR beacon 405-d. A STA 115 may thus expect subsequent WUR beacons 405 every T ms or in (T−t₁)ms from any delayed WUR beacon 405.

Therefore, if a STA 115 misses a WUR beacon 405, the STA 115 may wait T ms to receive the subsequent WUR beacon 405, reducing losses in synchronization by STAs 115. The STA 115 may not identify CSMA/CA delays at the AP 105 for a given WUR beacon 405, but may still receive subsequent WUR beacons 405 before substantial clock drift has occurred, as the WUR beacons are transmitted according to a static interval T that is not relative to the timing of delayed transmissions (that were missed). For example, if a STA 115 misses WUR beacon 405-d, the STA 115 may expect WUR beacon 405-e to arrive T ms from the missed WUR beacon 405-d (e.g., 2T from WUR beacon 405-f). Because the AP 105 may transmit WUR beacon 405-e (T−t₁)ms after WUR beacon 405-d (e.g., (T+t₁)ms from WUR beacon 405-f), WUR beacon 405-e may indeed be transmitted 2T from WUR beacon 405-f (e.g., (T−t₁)+(T+t₁)=2T). As such, the example of synchronization timeline 401 may provide for increased probability of successful reception of subsequent WUR beacons 405 after one or more missed WUR beacons 405.

That is, synchronization timeline 401 may enable single instance WUR beacon 405 delays that do not accumulate (e.g., when one or more beacons are missed), resulting in improved synchronization. Timing information included in each WUR beacon 405 may indicate how much the WUR beacon 405 was delayed from the scheduled time. The next WUR beacon 405 schedule may return to the original schedule without the new delay. As such STAs 115 that miss a WUR beacon 405 may base their timing on previous regular beacon times. Each beacon is scheduled with a regular period of T and, if there is a delay (e.g., due to carrier sensing), the delay may be communicated in the beacon. After the delay, the next beacon may return to the regular schedule (e.g., except for any small delays the next beacon may have). STAs 115 that miss a beacon may know where to look for new beacons, and STAs 115 that receive the beacon will receive information to subtract out the delay and thereby infer where to look for the next beacon.

FIG. 5 illustrates examples of WUR frames 500 and 501 that support improved WUR synchronization techniques in accordance with various aspects of the present disclosure. In some examples, WUR frames 500 and 501 may implement aspects of WLAN 100. In some cases, WUR frame 500 and 501 formats may refer to formats of WUR beacons 205, transmissions 310, and/or WUR beacons 405 as described with reference to FIGS. 2 through 4.

WUR frame 500 may represent a general format of a WUR frame that includes a frame control field 505-a (e.g., for control information) and a transmission time indicator field 510-a (e.g., to indicate a value indicative of a transmission time a wakeup signal, such as the current WUR frame, or for a delta value associated with the transmission delay of the current WUR frame). In some cases, frame control field 505-a may include a flag 515-a indicating whether or not a transmission time indicator field 510 is present in the WUR frame. For example, flag 515-a may include a toggle bit (e.g., one bit) to indicate the presence of the optional delta subfield (e.g., transmission time indicator field 510-a). If the flag 515-a indicates no transmission time indicator field 510 is present, the flag 515-a may therefore implicitly indicate the WUR frame was sent on time (e.g., on schedule).

Transmission time indicator field 510-a may include information relating to the delay in the transmission of the current WUR frame from the announced or expected transmission time. The information may include the range of times from zero to the maximum transmission delay (e.g., 8 ms). In some cases, the information may be represented by a number of bits corresponding to a granularity (e.g., a time resolution) of timing information desired. As a special case, if the delay in transmission of the WUR frame exceeds the maximum transmission delay and/or the maximum delta value the transmission time indicator field 510-a can represent, all ones (e.g., ‘1’) may be transmitted over the delta field to indicate such an occurrence.

In some cases, the transmission time indicator field 510-a may represent or refer to a partial TSF field, which may include TSF information as described with reference to FIG. 3. The transmission time indicator field 510-a may be designed or constructed to include a reduced length of timing information compared to conventional (e.g., Wi-Fi) frames. One bit in the frame control field (e.g., the flag 515-a) may indicate whether any timing information is included as discussed above. In cases where the WUR frame 500 is transmitted on time, zero octets may be used for such timing information. However, in cases where the WUR frame 500 is delayed, two octets of bits may be used (e.g., to cover a range up to 65 ms). The average overhead may thus be represented as p+16*(1−p), where p is the probability when the WUR frame 500 is sent on time. Alternatively, in cases where the WUR frame 500 is delayed, one octet may be used (e.g., to cover a range up to 8 ms with 32 us granularity when the last 5 bits are set to ‘10000’). In such scenarios, the average overhead may be represented as p+8*(1−p), where p is the probability when a beacon is sent within 32 us of the schedule time. 32 us may represent only 16% of the drift in 1 second assuming a 200 ppm drift. In some cases, energy analysis may be added on the rounding. It is to be understood that the above numbers are included for the sake of explanation and are not limiting of scope.

WUR frame 501 may represent a more detailed example format of a WUR frame that may include a PHY header 520, a frame control field 505-b, a receiver identification (ID) field 525 (e.g., that includes an ID of an intended STA 115, which may be optional), an optional transmitter ID field 530 (e.g., that includes an ID of the AP 105 transmitting the WUR frame), a frame body field 535 (e.g., which may be optional), a transmission time indicator field 510-b, and a cyclic redundancy check field 540. All example fields are shown for illustrative purposes only, and may be rearranged or omitted without departing from the scope of the present disclosure.

Frame control field 505-b may include a flag 515-b indicating whether or not a transmission time indicator field 510 is present in the WUR frame as discussed above. Further, frame control field 505-b may include a flag 545 (e.g., which may be 1 or more bits of information) indicating a frame type associated with the WUR frame 501. For example, flag 545 may indicated the WUR frame 501 is a synchronization frame, a wakeup frame, etc. as techniques described herein may apply to any repeated (e.g., periodic or quasi-periodic) transmissions expected according to some predetermined scheduling.

Transmission time indicator field 510-b may include information relating to the delay in the transmission of the current WUR frame from the announced or expected transmission time. The information may include the range of times from zero to the maximum transmission delay (e.g., 8 ms). In some cases, the information may be represented by a number of bits corresponding to a granularity of timing information desired. As a special case, if the delay in transmission of the WUR frame exceeds the maximum transmission delay and/or the maximum delta value the transmission time indicator field 510-b can represent, all ones (e.g., ‘1’) may be transmitted over the transmission time indicator field to indicate such an occurrence.

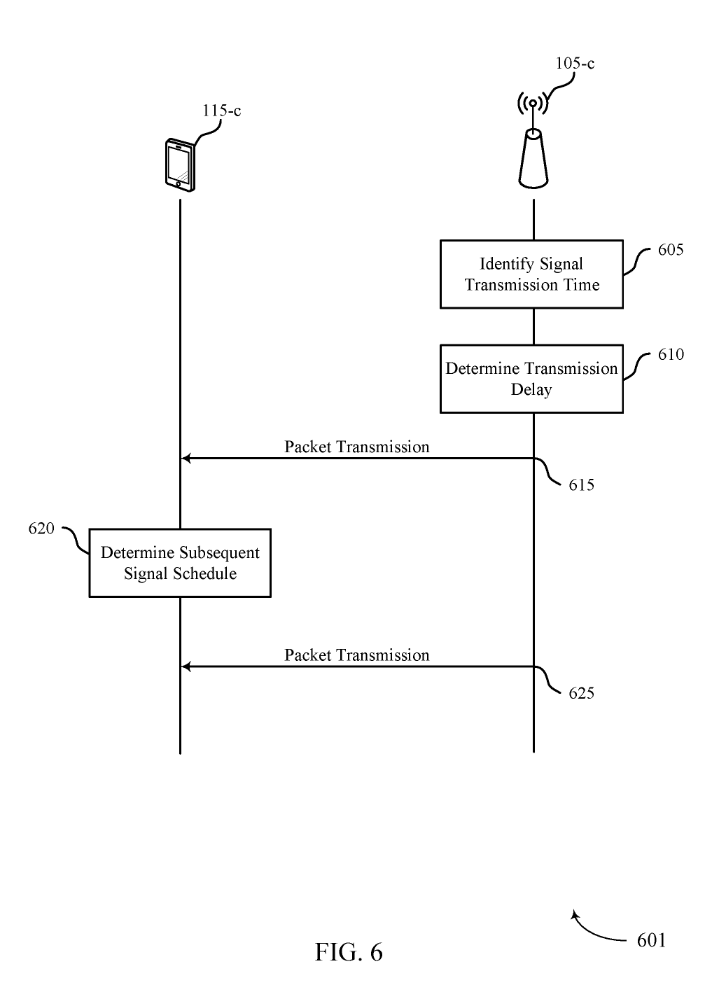

FIG. 6 illustrates an example of a process flow 600 that supports improved WUR synchronization techniques in accordance with various aspects of the present disclosure. In some examples, process flow 600 may implement aspects of WLAN 100. Process flow 600 may include AP 105-c and STA 115-c, which may be examples of a STA 115 or AP 105 as described herein. In some cases, process flow 600 may refer to transmission and reception of WUR beacons 205 as described with reference to FIG. 2.

At 605, AP 105-c may identify a transmission time for downlink signal transmission (e.g., a WUR beacon) to STA 115-c. In some cases, AP 105-c may perform a contention procedure prior to transmission of the signal (e.g., AP 105-c may perform a CSMA/CA procedure).

At 610, AP 105-c may determine a time difference between the identified transmission time and a scheduled transmission time. For example, if AP 105-c experiences delays in accessing the shared radio frequency spectrum band (e.g., due to contention procedures, other scheduled transmissions, etc.) the transmission time identified in 605 may be delayed relative to a scheduled transmission time.

At 615, AP 105-c may transmit the signal as a packet that includes a value indicative of the time difference delay determined at 610. The value may be contained within a field of the packet and indicated by a flag coordinated to determine presence of the said field. In some cases, the packet may contain a frame control field, with a flag constituting one or more bits of the frame control field. Additionally, or alternatively, the field may contain a single octet pattern of bits, or a multiple octet pattern of bits, for time difference indication. In some cases, the pattern of bits may indicate the delay is greater than a maximum delay threshold. The packet may include a WUR beacon, a WUR frame, a physical layer header, a frame control field, a receiver identifier field, a transmitted identifier field, a frame body field, a CRC field, etc. Additionally, the packet may provide a flag indication for notifying that the packet contains a WUR wakeup frame and synchronization beacon. AP 105-c may transmit the packet signal over shared radio frequency band resources, to STA 115-c.

At 620, STA 115-c may determine a schedule and/or a time period for a subsequent signal transmission from AP 105-c (e.g., a subsequent WUR beacon) based on the information included in the packet received at 615. That is, based on the scheduled transmission time, and the value indicative of the time difference, STA 115-c may determine a period for subsequent scheduled transmission reception.

STA 115-c may monitor system resources based on the schedule or time period determined at step 620. In accordance with the determination, STA 115-c may receive one or more subsequent packet transmission (e.g., such as a packet transmitted by AP 105-c at 625). That is, the timing of 625 where AP 105-c transmit the packet may be based on the delay determined at 610.

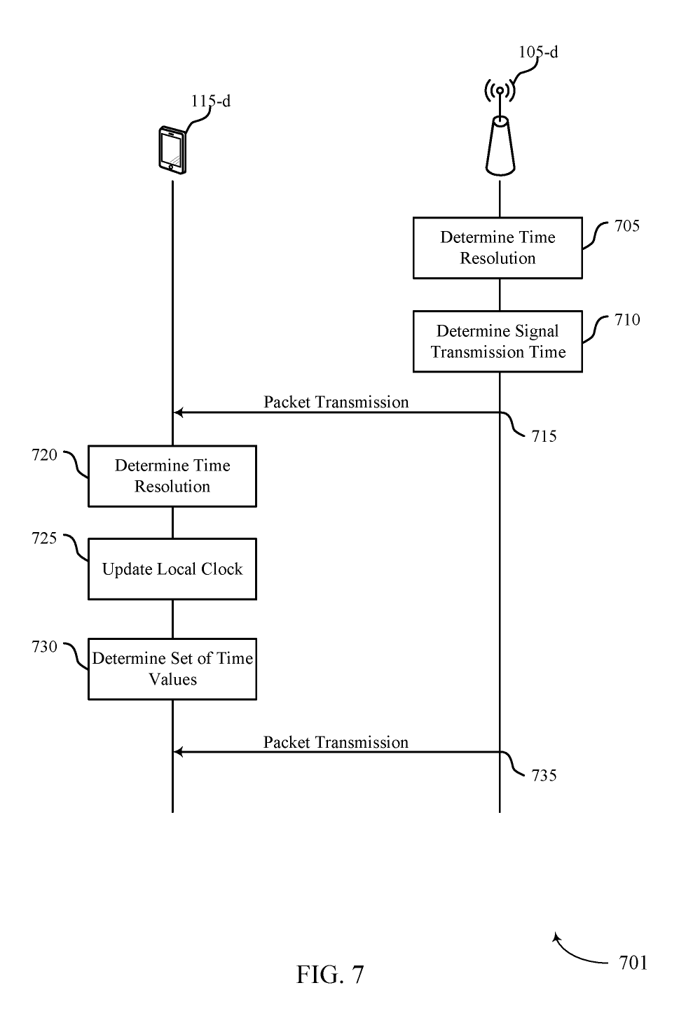

FIG. 7 illustrates an example of a process flow 700 that supports improved WUR synchronization techniques in accordance with various aspects of the present disclosure. In some examples, process flow 700 may implement aspects of WLAN 100. Process flow 700 may include AP 105-d and STA 115-d, which may be examples of a STA 115 or AP 105 as described herein. In some cases, process flow 700 may refer to transmission and reception of WUR beacons 205 described with reference to FIG. 2.

At 705, AP 105-d may determine a time resolution based on a clock drift associated with one or more STAs (e.g., STA 115-d). In some cases, AP 105-d and STA 115-d may exchange messages with STA 115-d via a main radio of STA 115-d (e.g., prior to STA 115-d powering down the main radio and operating the WUR) to determine the time resolution. That is, AP 105-d and STA 115-d may negotiate or handshake clock drift information and/or time resolution information prior to WUR synchronization beaconing. Based on the message exchange, AP 105-d may determine a time resolution based on, for example, a maximum clock drift value.

At 710, AP 105-d may identify a transmission time for downlink signal transmission (e.g., a WUR beacon) to STA 115-d. In some cases, AP 105-d may perform a contention procedure prior to transmission of the signal (e.g., AP 105-d may perform a CSMA/CA procedure). AP 105-d may determine a value indicative of the transmission time (e.g., partial TSF information associated with the time of the transmission at 715). That is, AP 105-d may determine a set of sequential time values (e.g., a sequence of points) based on the determined transmission time, an transmit a second signal (e.g., at 735) according to a next time value (e.g., point in time) of the sequence.

At 715, AP 105-d may transmit a packet containing the value determined at 710. The value may be contained within a field of the packet and indicated by a flag coordinated to determine presence of the said field. In some cases, the packet may contain a frame control field, with a flag constituting one or more bits of the frame control field. Additionally, or alternatively, the field may contain a single octet pattern of bits, or a multiple octet pattern of bits, indicative of the transmission time. The bit pattern may indicate a partial TSF value associated with the transmission time. The packet may include a WUR beacon, a WUR frame, a physical layer header, a frame control field, a receiver identifier field, a transmitted identifier field, a frame body field, or a CRC field. Additionally, the packet may include further indication of time resolution, and provide a flag indication for notifying that the packet contains a WUR wakeup frame and synchronization beacon. AP 105-c may transmit the packet signal over shared radio frequency band resources, to STA 115-c.

At 720, STA 115-d may determine a time resolution and timing information (e.g., partial TSF information of the AP 105-c at the time of step 715) form the received signal.

At 725, STA 115-d may use the determined timing information to set an updated value of the local clock. The updated value may be based on a local clock value, the received transmission time indication value, and one or more fields contained within the packet transmitted at 715.

At 730, STA 115-d may determine a set of sequential time values associated with subsequent transmissions from AP 105-d (e.g., based on the updated value of the local clock). STA 115-d may alter the clock timing of one of the time values of the set in accordance with the local clock value.

STA 115-d may use the clock timing, as updated at 730, to monitor for subsequent signal transmissions (e.g., to monitor at 735). The timing of 735 may correspond to a next time value of the set of sequential time values determined by AP 105-d at 710.

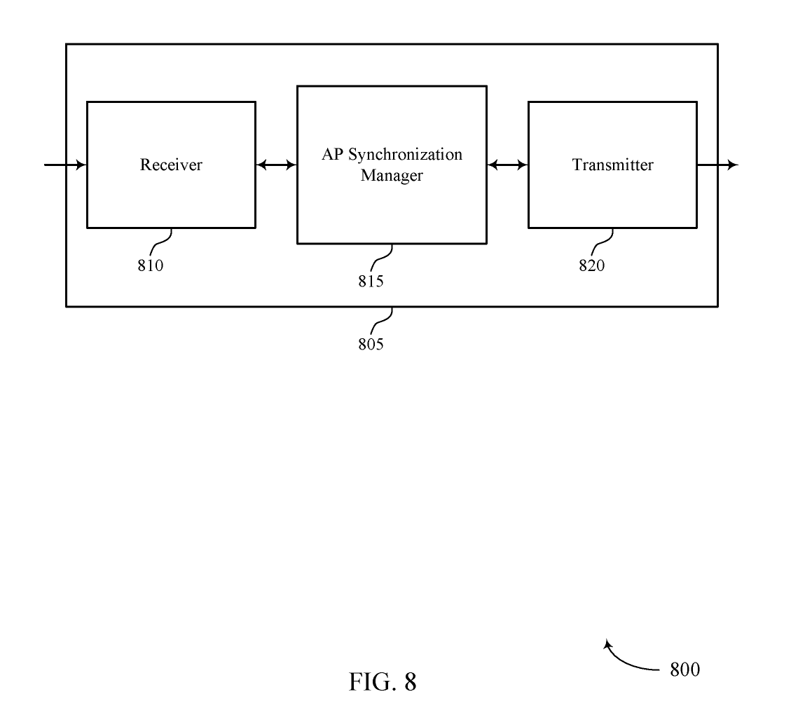

FIG. 8 shows a block diagram 800 of a wireless device 805 that supports improved WUR synchronization techniques in accordance with aspects of the present disclosure. Wireless device 805 may be an example of aspects of an AP 105 as described herein. Wireless device 805 may include receiver 810, AP synchronization manager 815, and transmitter 820. Wireless device 805 may also include a processor. Each of these components may be in communication with one another (e.g., via one or more buses).

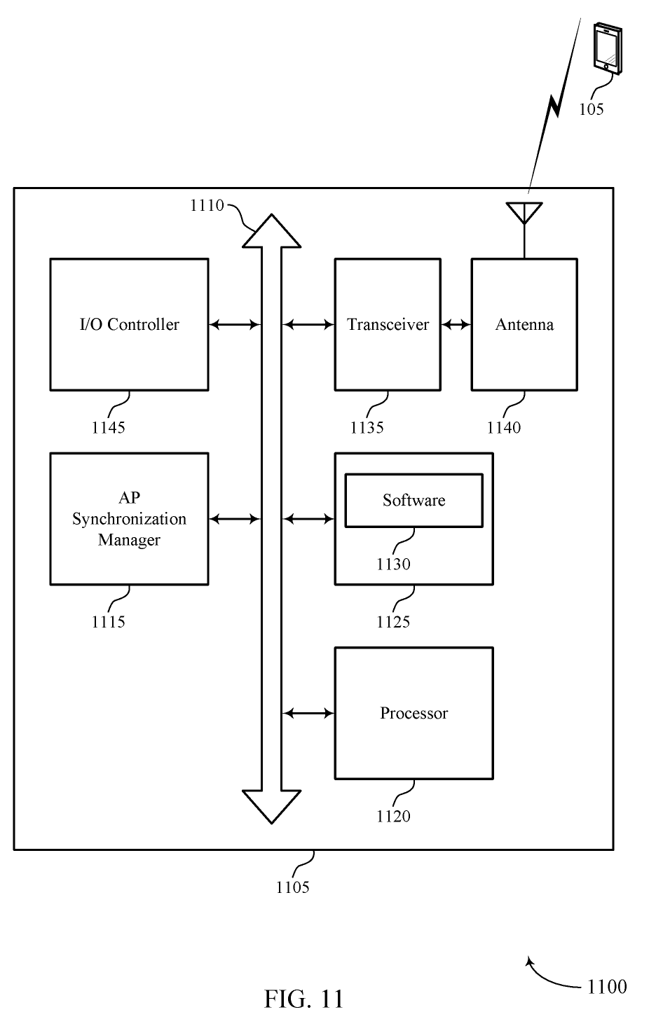

Receiver 810 may receive information such as packets, user data, or control information associated with various information channels (e.g., control channels, data channels, and information related to improved WUR synchronization techniques, etc.). Information may be passed on to other components of the device. The receiver 810 may be an example of aspects of the transceiver 1135 described with reference to FIG. 11. The receiver 810 may utilize a single antenna or a set of antennas.

AP synchronization manager 815 may be an example of aspects of the AP synchronization manager 1115 described with reference to FIG. 11. AP synchronization manager 815 and/or at least some of its various sub-components may be implemented in hardware, software executed by a processor, firmware, or any combination thereof. If implemented in software executed by a processor, the functions of the AP synchronization manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The AP synchronization manager 815 and/or at least some of its various sub-components may be physically located at various positions, including being distributed such that portions of functions are implemented at different physical locations by one or more physical devices. In some examples, AP synchronization manager 815 and/or at least some of its various sub-components may be a separate and distinct component in accordance with various aspects of the present disclosure. In other examples, AP synchronization manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP synchronization manager 815 may identify an actual transmission time for a signal, determine a time difference between the actual transmission time and a scheduled transmission time for the signal, where the time difference is based at least in part on a delay in accessing the shared radio frequency spectrum band or a delay resulting from a different scheduled transmission, and transmit the signal as a packet that includes a value indicative of the time difference between the actual transmission time and the scheduled transmission time. The AP synchronization manager 815 may also determine a time resolution based on a clock drift for one or more STAs, determine a transmission time for a signal, and transmit the signal as a packet that includes a value indicative of the transmission time and based on the time resolution.

The AP synchronization manager 815 may also determine a time resolution for values indicative of wakeup signal transmission times based at least in part on a wakeup schedule of a station (STA) and a clock drift value for the STA, transmit, to a primary radio of the STA, an indication of the time resolution, identify a transmission time of a wakeup signal for the STA, determine a value indicative of the transmission time of the wakeup signal based at least in part on the transmission time and the time resolution, and transmit, to a wakeup radio of the STA, the wakeup signal as a packet that comprises the value indicative of the transmission time of the wakeup signal.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may utilize a single antenna or a set of antennas.

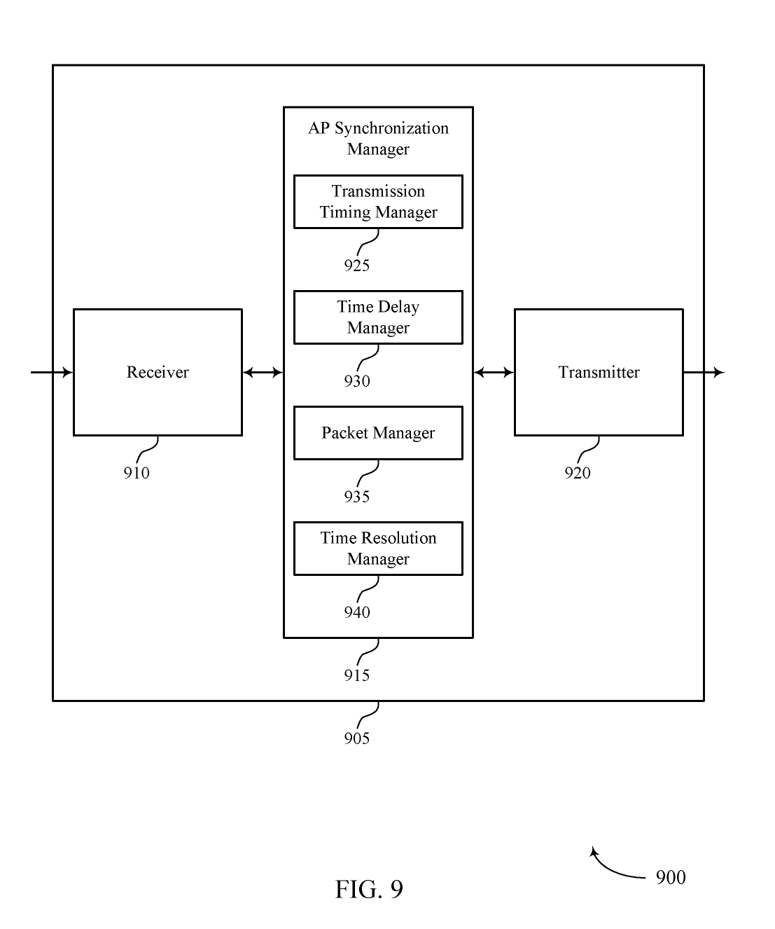

FIG. 9 shows a block diagram 900 of a wireless device 905 that supports improved WUR synchronization techniques in accordance with aspects of the present disclosure. Wireless device 905 may be an example of aspects of a wireless device 805 or an AP 105 as described with reference to FIG. 8. Wireless device 905 may include receiver 910, AP synchronization manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to improved WUR synchronization techniques, etc.). Information may be passed on to other components of the device. The receiver 910 may be an example of aspects of the transceiver 1135 described with reference to FIG. 11. The receiver 910 may utilize a single antenna or a set of antennas.

AP synchronization manager 915 may be an example of aspects of the AP synchronization manager 1115 described with reference to FIG. 11. AP synchronization manager 915 may also include transmission timing manager 925, time delay manager 930, packet manager 935, and time resolution manager 940.

Transmission timing manager 925 may identify an actual transmission time for a signal. Transmission timing manager 925 may determine a transmission time for a signal. Transmission timing manager 925 may determine a set of sequential time values based on the transmission time. In some cases, the signal includes a WUR synchronization beacon or a WUR wakeup frame. In some cases, the signal is a periodic signal or an aperiodic signal.

Time delay manager 930 may determine a time difference between the actual transmission time and a scheduled transmission time for the signal, where the time difference is based at least in part on a delay in accessing the shared radio frequency spectrum band or a delay resulting from a different scheduled transmission. In some cases, the time difference is based on the delay in accessing the shared radio frequency spectrum band, and the delay includes a delay due to a carrier sense operation. In some cases, the time difference is based on the delay resulting from a different scheduled transmission.

Packet manager 935 may transmit the signal as a packet that includes a value indicative of the time difference between the actual transmission time and the scheduled transmission time. Packet manager 935 may transmit the signal as a packet that includes a value indicative of the transmission time and based on the time resolution. Packet manager 935 may transmit a second signal based on a next time value of the set that follows the transmission time for the signal. In some cases, the packet includes a flag that indicates that the packet includes a synchronization frame or a wakeup frame. In some cases, the packet includes a flag that indicates a presence of the field. In some cases, the packet includes a frame control field, and where the flag include one or more bits of the frame control field. In some cases, the field includes a pattern of bits indicative of the time difference between the actual transmission time and the scheduled transmission time. In some cases, the pattern of bits includes two octets. In some cases, the pattern of bits includes one octet.

In some cases, the pattern of bits indicates that the time difference between the actual transmission time and the scheduled transmission time is greater than a threshold. In some cases, the packet includes at least one of a physical layer header, a frame control field, a receiver identifier filed, a transmitter identifier field, a frame body field, or CRC field, or any combination thereof. In some cases, the packet includes a flag that indicates that the packet includes a synchronization frame or a wakeup frame. In some cases, the value indicative of the time difference between the actual transmission time and the scheduled transmission time includes a field within the packet. In some cases, the value indicative of the transmission time includes a field within the packet. In some cases, the packet includes a flag that indicates a presence of the field. In some cases, the packet includes a frame control field, and where the flag include one or more bits of the frame control field. In some cases, the field includes a pattern of bits indicative of the transmission time. In some cases, the pattern of bits includes two octets. In some cases, the pattern of bits includes one octet. In some cases, the pattern of bits indicates a partial TSF value associated with the transmission time. In some cases, the packet further indicates the time resolution. In some cases, the time resolution is based on a maximum clock drift value. In some cases, the packet includes at least one of a physical layer header, a frame control field, a receiver identifier filed, a transmitter identifier field, a frame body field, or CRC field, or any combination thereof.

Time resolution manager 940 may determine a time resolution for values indicative of wakeup signal transmission times based at least in part on a wakeup schedule of a STA and a clock drift value for the STA. Time resolution manager 940 may determine a time resolution based on a clock drift for one or more STAs and determine the time resolution based on a message exchange with the one or more STAs prior to transmitting the signal. In some cases, the message exchange is performed using a first radio of the one or more STAs. In some cases, the transmissions associated with the first radio include a higher bit rate than transmissions associated with the transmitted signal.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may utilize a single antenna or a set of antennas.

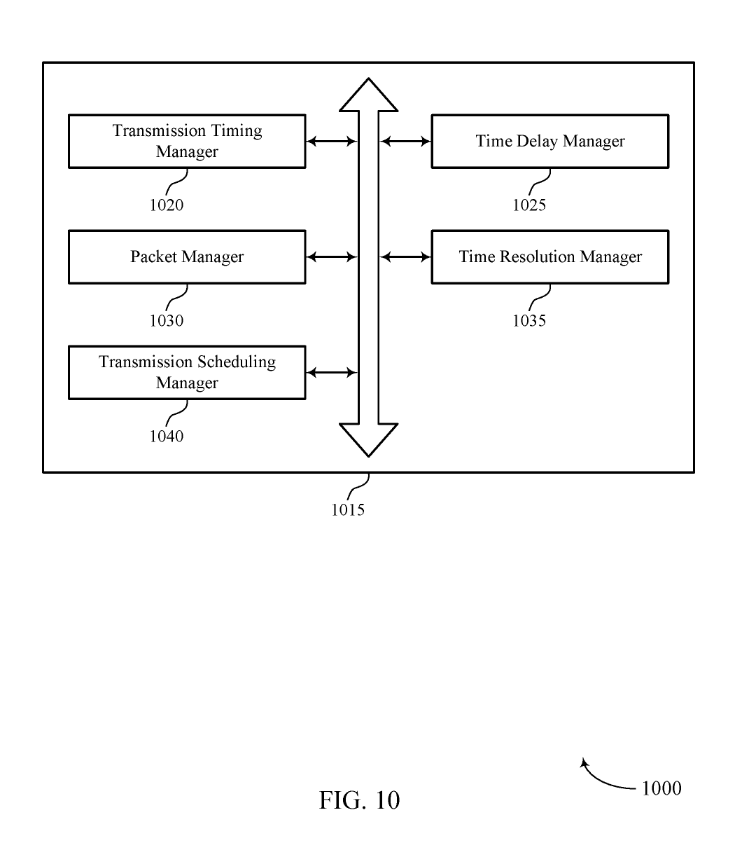

FIG. 10 shows a block diagram 1000 of an AP synchronization manager 1015 that supports improved WUR synchronization techniques in accordance with aspects of the present disclosure. The AP synchronization manager 1015 may be an example of aspects of an AP synchronization manager 815, an AP synchronization manager 915, or an AP synchronization manager 1115 described with reference to FIGS. 8, 9, and 11. The AP synchronization manager 1015 may include transmission timing manager 1020, time delay manager 1025, packet manager 1030, time resolution manager 1035, and transmission scheduling manager 1040. Each of these modules may communicate, directly or indirectly, with one another (e.g., via one or more buses).

Transmission timing manager 1020 may identify an actual transmission time for a signal. Transmission timing manager 1020 may determine a transmission time for a signal. Transmission timing manager 1020 may determine a set of sequential time values based on the transmission time. In some cases, the signal includes a WUR synchronization beacon or a WUR wakeup frame. In some cases, the signal is a periodic signal or an aperiodic signal.

Time delay manager 1025 may determine a time difference between the actual transmission time and a scheduled transmission time for the signal, where the time difference is based at least in part on a delay in accessing the shared radio frequency spectrum band or a delay resulting from a different scheduled transmission. In some cases, the time difference is based on the delay in accessing the shared radio frequency spectrum band, and the delay includes a delay due to a carrier sense operation. In some cases, the time difference is based on the delay resulting from a different scheduled transmission.

Packet manager 1030 may transmit the signal as a packet that includes a value indicative of the time difference between the actual transmission time and the scheduled transmission time. Packet manager 1030 may transmit the signal as a packet that includes a value indicative of the transmission time and based on the time resolution. Packet manager 1030 may transmit a second signal based on a next time value of the set that follows the transmission time for the signal. In some cases, the packet includes a flag that indicates that the packet includes a synchronization frame or a wakeup frame. In some cases, the packet includes a flag that indicates a presence of the field. In some cases, the packet includes a frame control field, and where the flag include one or more bits of the frame control field. In some cases, the field includes a pattern of bits indicative of the time difference between the actual transmission time and the scheduled transmission time. In some cases, the pattern of bits includes two octets.

In some cases, the pattern of bits includes one octet. In some cases, the pattern of bits indicates that the time difference between the actual transmission time and the scheduled transmission time is greater than a threshold. In some cases, the packet includes at least one of a physical layer header, a frame control field, a receiver identifier filed, a transmitter identifier field, a frame body field, or CRC field, or any combination thereof. In some cases, the packet includes a flag that indicates that the packet includes a synchronization frame or a wakeup frame. In some cases, the value indicative of the time difference between the actual transmission time and the scheduled transmission time includes a field within the packet.

In some cases, the value indicative of the transmission time includes a field within the packet. In some cases, the packet includes a flag that indicates a presence of the field. In some cases, the packet includes a frame control field, and where the flag include one or more bits of the frame control field. In some cases, the field includes a pattern of bits indicative of the transmission time. In some cases, the pattern of bits includes two octets. In some cases, the pattern of bits includes one octet. In some cases, the pattern of bits indicates a partial TSF value associated with the transmission time. In some cases, the packet further indicates the time resolution. In some cases, the time resolution is based on a maximum clock drift value. In some cases, the packet includes at least one of a physical layer header, a frame control field, a receiver identifier filed, a transmitter identifier field, a frame body field, or CRC field, or any combination thereof.

Time resolution manager 1035 may determine a time resolution based on a clock drift for one or more STAs. Time resolution manager 1035 may determine the time resolution based on a message exchange with the one or more STAs prior to transmitting the signal. In some cases, the message exchange is performed using a first radio of the one or more STAs. In some cases, the transmissions associated with the first radio include a higher bit rate than transmissions associated with the transmitted signal.

Transmission scheduling manager 1040 may transmit a subsequent packet after transmitting the packet, where the subsequent packet is transmitted based on the scheduled transmission time. Transmission scheduling manager 1040 may transmit a prior packet before transmitting the packet, where the prior packet is transmitted based on the scheduled transmission time.

FIG. 11 shows a diagram of a system 1100 including a device 1105 that supports improved WUR synchronization techniques in accordance with aspects of the present disclosure. Device 1105 may be an example of or include the components of wireless device 805, wireless device 905, or an AP 105 as described above, e.g., with reference to FIGS. 8 and 9. Device 1105 may include components for bi-directional voice and data communications including components for transmitting and receiving communications, including AP synchronization manager 1115, processor 1120, memory 1125, software 1130, transceiver 1135, antenna 1140, and I/O controller 1145. These components may be in electronic communication via one or more buses (e.g., bus 1110).

Processor 1120 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting improved WUR synchronization techniques).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support improved WUR synchronization techniques. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas. In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system. In other cases, I/O controller 1145 may represent or interact with a modem, a keyboard, a mouse, a touchscreen, or a similar device. In some cases, I/O controller 1145 may be implemented as part of a processor. In some cases, a user may interact with device 1105 via I/O controller 1145 or via hardware components controlled by I/O controller 1145.

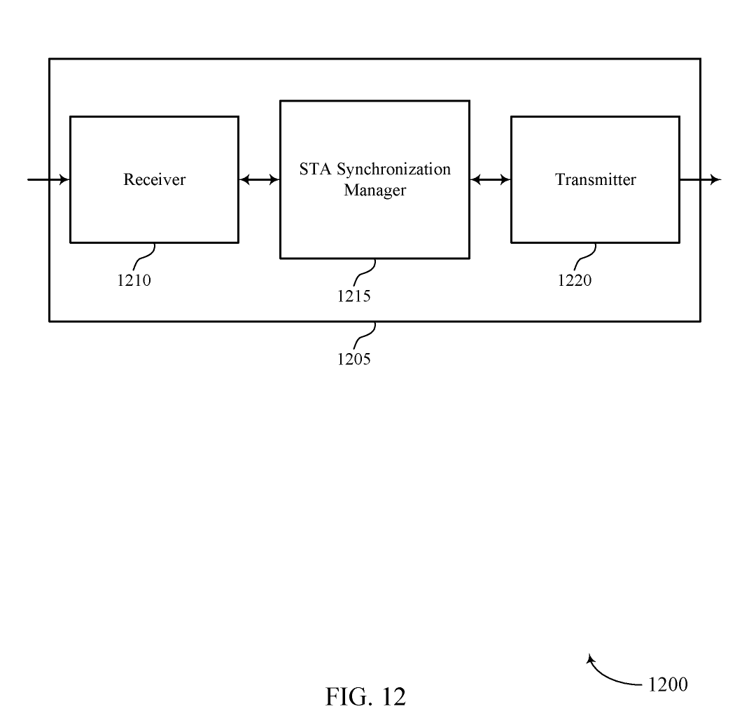

FIG. 12 shows a block diagram 1200 of a wireless device 1205 that supports improved WUR synchronization techniques in accordance with aspects of the present disclosure. Wireless device 1205 may be an example of aspects of a STA 115 as described herein. Wireless device 1205 may include receiver 1210, STA synchronization manager 1215, and transmitter 1220. Wireless device 1205 may also include a processor. Each of these components may be in communication with one another (e.g., via one or more buses).

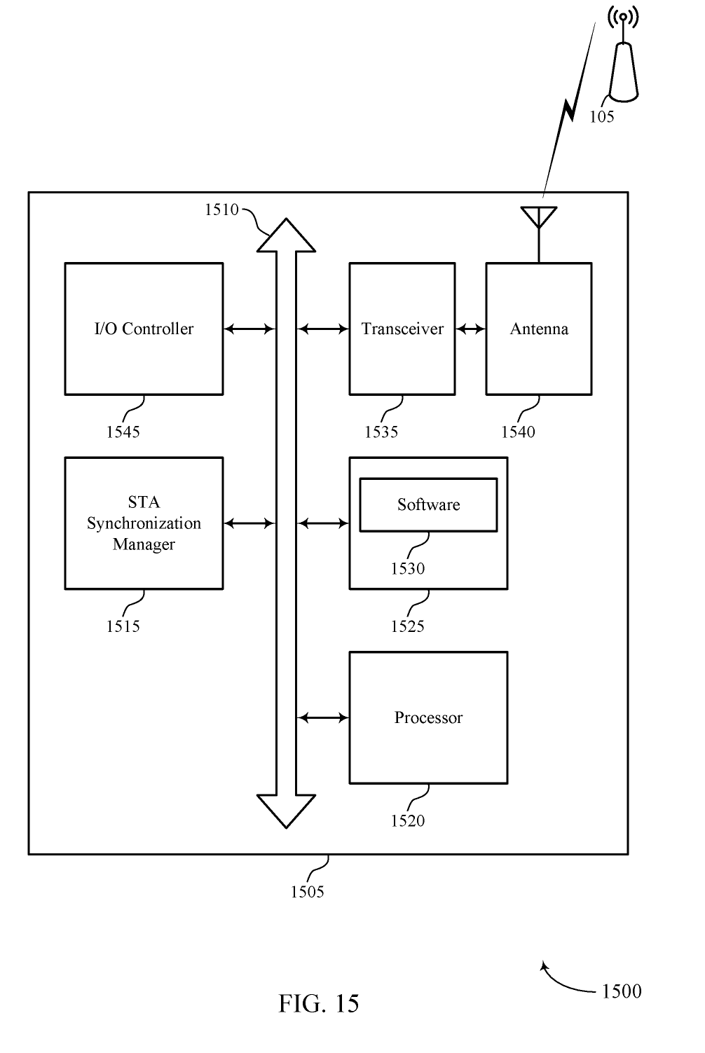

Receiver 1210 may receive information such as packets, user data, or control information associated with various information channels (e.g., control channels, data channels, and information related to improved WUR synchronization techniques, etc.). Information may be passed on to other components of the device. The receiver 1210 may be an example of aspects of the transceiver 1535 described with reference to FIG. 15. The receiver 1210 may utilize a single antenna or a set of antennas.

STA synchronization manager 1215 may be an example of aspects of the STA synchronization manager 1515 described with reference to FIG. 15. STA synchronization manager 1215 and/or at least some of its various sub-components may be implemented in hardware, software executed by a processor, firmware, or any combination thereof. If implemented in software executed by a processor, the functions of the STA synchronization manager 1215 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The STA synchronization manager 1215 and/or at least some of its various sub-components may be physically located at various positions, including being distributed such that portions of functions are implemented at different physical locations by one or more physical devices. In some examples, STA synchronization manager 1215 and/or at least some of its various sub-components may be a separate and distinct component in accordance with various aspects of the present disclosure. In other examples, STA synchronization manager 1215 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA synchronization manager 1215 may receive a signal as a packet that includes a value indicative of a time difference between an actual transmission time and a scheduled transmission time, where the time difference is based at least in part on a delay in accessing the shared radio frequency spectrum band or a delay resulting from a different scheduled transmission, determine a time period to monitor for a subsequent signal based on the scheduled transmission time and the value indicative of a time difference between the actual transmission time and the scheduled transmission time, and monitor for the subsequent signal during the time period based on the determining. The STA synchronization manager 1215 may also receive a signal as a packet that includes a first value indicative of an actual transmission time, determine a time resolution of the first value, and set a clock timing based on a local clock value, the received first value, and the determined time resolution.

STA synchronization manager 1215 may receive, using a primary radio, an indication of a time resolution for values indicative of wakeup signal transmission times, receive, using a wakeup radio and based at least in part on a wakeup schedule of the STA, a wakeup signal as a packet that comprises a value indicative of a transmission time of the wakeup signal, determine the transmission time of the wakeup signal based at least in part on the wakeup schedule, the indication of the time resolution, and the value indicative of the transmission time, and update a local clock timing based at least in part on the transmission time.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1535 described with reference to FIG. 15. The transmitter 1220 may utilize a single antenna or a set of antennas.

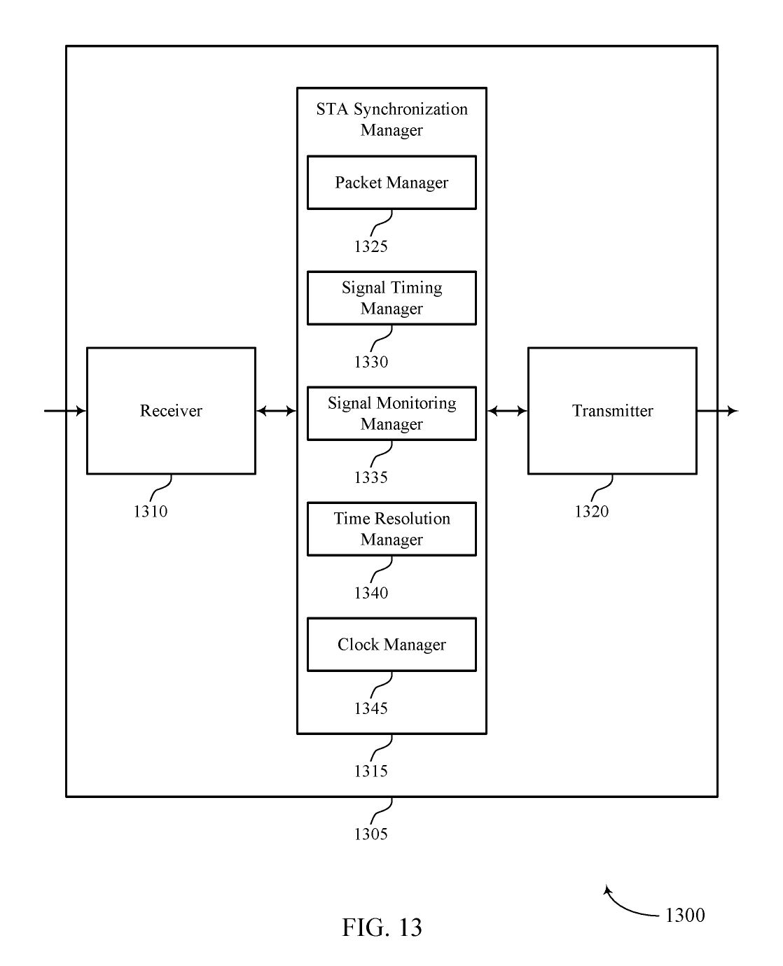

FIG. 13 shows a block diagram 1300 of a wireless device 1305 that supports improved WUR synchronization techniques in accordance with aspects of the present disclosure. Wireless device 1305 may be an example of aspects of a wireless device 1205 or a STA 115 as described with reference to FIG. 12. Wireless device 1305 may include receiver 1310, STA synchronization manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to improved WUR synchronization techniques, etc.). Information may be passed on to other components of the device. The receiver 1310 may be an example of aspects of the transceiver 1535 described with reference to FIG. 15. The receiver 1310 may utilize a single antenna or a set of antennas.

STA synchronization manager 1315 may be an example of aspects of the STA synchronization manager 1515 described with reference to FIG. 15. STA synchronization manager 1315 may also include packet manager 1325, signal timing manager 1330, signal monitoring manager 1335, time resolution manager 1340, and clock manager 1345.

Packet manager 1325 may receive a signal as a packet that includes a value indicative of a time difference between an actual transmission time and a scheduled transmission time, where the time difference is based at least in part on a delay in accessing the shared radio frequency spectrum band or a delay resulting from a different scheduled transmission. Packet manager 1325 may receive a prior packet before receiving the packet. Packet manager 1325 may receive a signal as a packet that includes a first value indicative of an actual transmission time. In some cases, the signal includes a periodic signal or an aperiodic signal. In some cases, the time difference is based on the delay resulting from a different scheduled transmission. In some cases, the signal includes a WUR synchronization beacon. In some cases, the signal includes a WUR wakeup frame.

In some cases, the signal includes a periodic signal or an aperiodic signal. In some cases, the value indicative of the time difference between the actual transmission time and the scheduled transmission time includes a field within the packet. In some cases, the packet includes a flag that indicates a presence of the field. In some cases, the packet includes a frame control field, and where the flag include one or more bits of the frame control field. In some cases, the field includes a pattern of bits indicative of the time difference between the actual transmission time and the scheduled transmission time. In some cases, the pattern of bits includes two octets. In some cases, the pattern of bits includes one octet. In some cases, the pattern of bits indicates that the time difference between the actual transmission time and the scheduled transmission time is greater than a threshold. In some cases, the packet includes at least one of a physical layer header, a frame control field, a receiver identifier filed, a transmitter identifier field, a frame body field, or CRC field, or any combination thereof. In some cases, the packet includes a flag that indicates that the packet includes a synchronization frame or a wakeup frame.

In some cases, the time difference is based on the delay in accessing the shared radio frequency spectrum band, and the delay includes a delay due to a carrier sense operation. In some cases, the packet includes at least one of a physical layer header, a frame control field, a receiver identifier filed, a transmitter identifier field, a frame body field, or CRC field, or any combination thereof. In some cases, the packet includes a flag that indicates that the packet includes a synchronization frame or a wakeup frame. In some cases, the first value indicative of the transmission time includes a field within the packet. In some cases, the packet includes a flag that indicates a presence of the field. In some cases, the packet includes a frame control field, and where the flag includes one or more bits of the frame control field.

In some cases, the field includes a pattern of bits indicative of the transmission time. In some cases, the pattern of bits includes one octet. In some cases, the pattern of bits indicates a partial TSF value associated with the transmission. In some cases, the packet further indicates the time resolution. In some cases, the resolution is based on a maximum clock drift value. In some cases, the time resolution is determined based on a message exchange with an access point prior to receiving the signal. In some cases, the message exchange is performed using a first radio and the signal is received using a second radio. In some cases, the message exchange performed using the first radio includes a higher bit rate than the signal associated with the second radio. In some cases, the signal includes a WUR synchronization beacon. In some cases, the signal includes a WUR wakeup frame.

Signal timing manager 1330 may determine a time period to monitor for a subsequent signal based on the scheduled transmission time and the value indicative of a time difference between the actual transmission time and the scheduled transmission time. Signal monitoring manager 1335 may monitor for the subsequent signal during the time period based on the determining and monitor for a subsequent signal based on the set clock timing. Time resolution manager 1340 may determine a time resolution of the first value.

Clock manager 1345 may set a clock timing based on a local clock value, the received first value, and the determined time resolution and set the clock timing to one of the time values of the set based on the local clock value. In some cases, setting the clock timing includes: determining an updated value of the local clock based on the received first value and the determined time resolution.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1535 described with reference to FIG. 15. The transmitter 1320 may utilize a single antenna or a set of antennas.

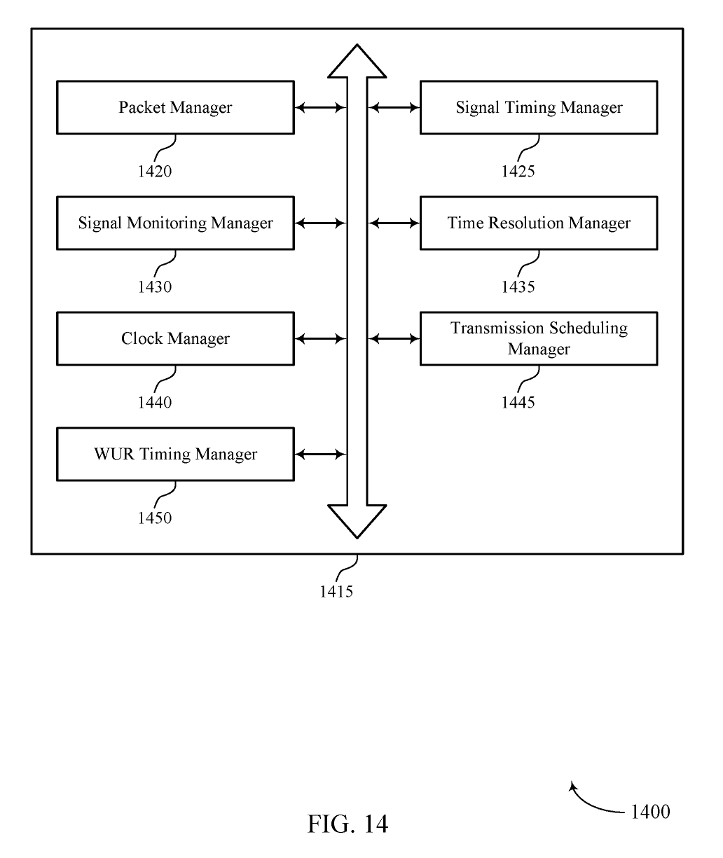

FIG. 14 shows a block diagram 1400 of a STA synchronization manager 1415 that supports improved WUR synchronization techniques in accordance with aspects of the present disclosure. The STA synchronization manager 1415 may be an example of aspects of a STA synchronization manager 1515 described with reference to FIGS. 12, 13, and 15. The STA synchronization manager 1415 may include packet manager 1420, signal timing manager 1425, signal monitoring manager 1430, time resolution manager 1435, clock manager 1440, transmission scheduling manager 1445, and WUR timing manager 1450. Each of these modules may communicate, directly or indirectly, with one another (e.g., via one or more buses).

Packet manager 1420 may receive a signal as a packet that includes a value indicative of a time difference between an actual transmission time and a scheduled transmission time, where the time difference is based at least in part on a delay in accessing the shared radio frequency spectrum band or a delay resulting from a different scheduled transmission, receive a prior packet before receiving the packet, and receive a signal as a packet that includes a first value indicative of an actual transmission time. In some cases, the signal includes a periodic signal or an aperiodic signal. In some cases, the time difference is based on the delay resulting from a different scheduled transmission. In some cases, the signal includes a WUR synchronization beacon. In some cases, the signal includes a WUR wakeup frame. In some cases, the signal includes a periodic signal or an aperiodic signal. In some cases, the value indicative of the time difference between the actual transmission time and the scheduled transmission time includes a field within the packet.

In some cases, the packet includes a flag that indicates a presence of the field. In some cases, the packet includes a frame control field, and where the flag include one or more bits of the frame control field. In some cases, the field includes a pattern of bits indicative of the time difference between the actual transmission time and the scheduled transmission time. In some cases, the pattern of bits includes two octets. In some cases, the pattern of bits includes one octet. In some cases, the pattern of bits indicates that the time difference between the actual transmission time and the scheduled transmission time is greater than a threshold. In some cases, the packet includes at least one of a physical layer header, a frame control field, a receiver identifier filed, a transmitter identifier field, a frame body field, or CRC field, or any combination thereof. In some cases, the packet includes a flag that indicates that the packet includes a synchronization frame or a wakeup frame. In some cases, the time difference is based on the delay in accessing the shared radio frequency spectrum band, and the delay includes a delay due to a carrier sense operation.

In some cases, the packet includes at least one of a physical layer header, a frame control field, a receiver identifier filed, a transmitter identifier field, a frame body field, or CRC field, or any combination thereof. In some cases, the packet includes a flag that indicates that the packet includes a synchronization frame or a wakeup frame. In some cases, the first value indicative of the transmission time includes a field within the packet. In some cases, the packet includes a flag that indicates a presence of the field. In some cases, the packet includes a frame control field, and where the flag includes one or more bits of the frame control field. In some cases, the field includes a pattern of bits indicative of the transmission time. In some cases, the pattern of bits includes one octet. In some cases, the pattern of bits indicates a partial TSF value associated with the transmission. In some cases, the packet further indicates the time resolution. In some cases, the resolution is based on a maximum clock drift value. In some cases, the time resolution is determined based on a message exchange with an access point prior to receiving the signal. In some cases, the message exchange is performed using a first radio and the signal is received using a second radio. In some cases, the message exchange performed using the first radio includes a higher bit rate than the signal associated with the second radio. In some cases, the signal includes a WUR synchronization beacon. In some cases, the signal includes a WUR wakeup frame.

Signal timing manager 1425 may determine a time period to monitor for a subsequent signal based on the scheduled transmission time and the value indicative of a time difference between the actual transmission time and the scheduled transmission time.

Signal monitoring manager 1430 may monitor for the subsequent signal during the time period based on the determining and monitor for a subsequent signal based on the set clock timing.

Time resolution manager 1435 may determine a time resolution of the first value. Clock manager 1440 may set a clock timing based on a local clock value, the received first value, and the determined time resolution and set the clock timing to one of the time values of the set based on the local clock value. In some cases, setting the clock timing includes: determining an updated value of the local clock based on the received first value and the determined time resolution.

Transmission scheduling manager 1445 may determine the scheduled transmission time based on another value indicated in the prior packet. WUR timing manager 1450 may determine a set of sequential time values based on the updated value.

FIG. 15 shows a diagram of a system 1500 including a device 1505 that supports improved WUR synchronization techniques in accordance with aspects of the present disclosure. Device 1505 may be an example of or include the components of STA 115 as described above, e.g., with reference to FIG. 1. Device 1505 may include components for bi-directional voice and data communications including components for transmitting and receiving communications, including STA synchronization manager 1515, processor 1520, memory 1525, software 1530, transceiver 1535, antenna 1540, and I/O controller 1545. These components may be in electronic communication via one or more buses (e.g., bus 1510).

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting improved WUR synchronization techniques).

Memory 1525 may include RAM and ROM. The memory 1525 may store computer-readable, computer-executable software 1530 including instructions that, when executed, cause the processor to perform various functions described herein. In some cases, the memory 1525 may contain, among other things, a BIOS which may control basic hardware and/or software operation such as the interaction with peripheral components or devices.

Software 1530 may include code to implement aspects of the present disclosure, including code to support improved WUR synchronization techniques. Software 1530 may be stored in a non-transitory computer-readable medium such as system memory or other memory. In some cases, the software 1530 may not be directly executable by the processor but may cause a computer (e.g., when compiled and executed) to perform functions described herein.

Transceiver 1535 may communicate bi-directionally, via one or more antennas, wired, or wireless links as described above. For example, the transceiver 1535 may represent a wireless transceiver and may communicate bi-directionally with another wireless transceiver. The transceiver 1535 may also include a modem to modulate the packets and provide the modulated packets to the antennas for transmission, and to demodulate packets received from the antennas.

In some cases, the wireless device may include a single antenna 1540. However, in some cases the device may have more than one antenna 1540, which may be capable of concurrently transmitting or receiving multiple wireless transmissions.

I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system. In other cases, I/O controller 1545 may represent or interact with a modem, a keyboard, a mouse, a touchscreen, or a similar device. In some cases, I/O controller 1545 may be implemented as part of a processor. In some cases, a user may interact with device 1505 via I/O controller 1545 or via hardware components controlled by I/O controller 1545.

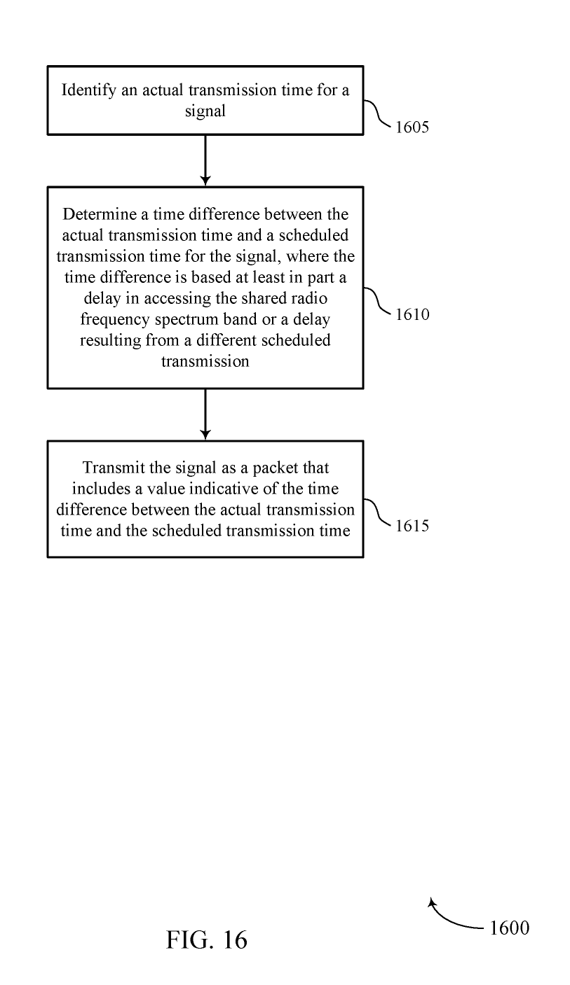

FIG. 16 shows a flowchart illustrating a method 1600 for improved WUR synchronization techniques in accordance with aspects of the present disclosure. The operations of method 1600 may be implemented by an AP 105 or its components as described herein. For example, the operations of method 1600 may be performed by an AP synchronization manager as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1605 the AP 105 may identify an actual transmission time for a signal. The operations of block 1605 may be performed according to the methods described herein. In certain examples, aspects of the operations of block 1605 may be performed by a transmission timing manager as described with reference to FIGS. 8 through 11.

At block 1610 the AP 105 may determine a time difference between the actual transmission time and a scheduled transmission time for the signal, wherein the time difference is based at least in part on a delay in accessing the shared radio frequency spectrum band or a delay resulting from a different scheduled transmission. The operations of block 1610 may be performed according to the methods described herein. In certain examples, aspects of the operations of block 1610 may be performed by a time delay manager as described with reference to FIGS. 8 through 11.

At block 1615 the AP 105 may transmit the signal as a packet that comprises a value indicative of the time difference between the actual transmission time and the scheduled transmission time. The operations of block 1615 may be performed according to the methods described herein. In certain examples, aspects of the operations of block 1615 may be performed by a packet manager as described with reference to FIGS. 8 through 11.

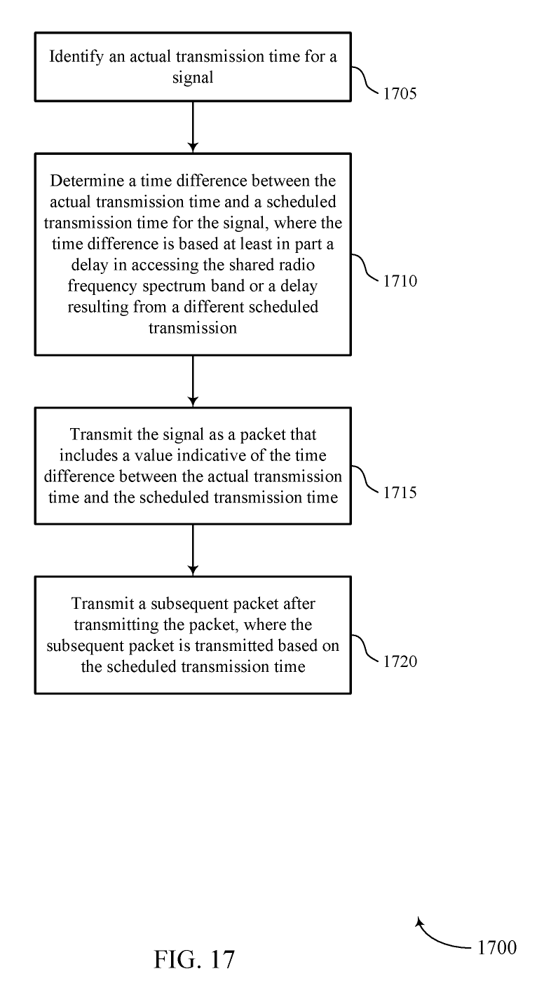

FIG. 17 shows a flowchart illustrating a method 1700 for improved WUR synchronization techniques in accordance with aspects of the present disclosure. The operations of method 1700 may be implemented by an AP 105 or its components as described herein. For example, the operations of method 1700 may be performed by an AP synchronization manager as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1705 the AP 105 may identify an actual transmission time for a signal. The operations of block 1705 may be performed according to the methods described herein. In certain examples, aspects of the operations of block 1705 may be performed by a transmission timing manager as described with reference to FIGS. 8 through 11.

At block 1710 the AP 105 may determine a time difference between the actual transmission time and a scheduled transmission time for the signal, wherein the time difference is based at least in part on a delay in accessing the shared radio frequency spectrum band or a delay resulting from a different scheduled transmission. The operations of block 1710 may be performed according to the methods described herein. In certain examples, aspects of the operations of block 1710 may be performed by a time delay manager as described with reference to FIGS. 8 through 11.

At block 1715 the AP 105 may transmit the signal as a packet that comprises a value indicative of the time difference between the actual transmission time and the scheduled transmission time. The operations of block 1715 may be performed according to the methods described herein. In certain examples, aspects of the operations of block 1715 may be performed by a packet manager as described with reference to FIGS. 8 through 11.

At block 1720 the AP 105 may transmit a subsequent packet after transmitting the packet, wherein the subsequent packet is transmitted based at least in part on the scheduled transmission time. The operations of block 1720 may be performed according to the methods described herein. In certain examples, aspects of the operations of block 1720 may be performed by a transmission scheduling manager as described with reference to FIGS. 8 through 11.

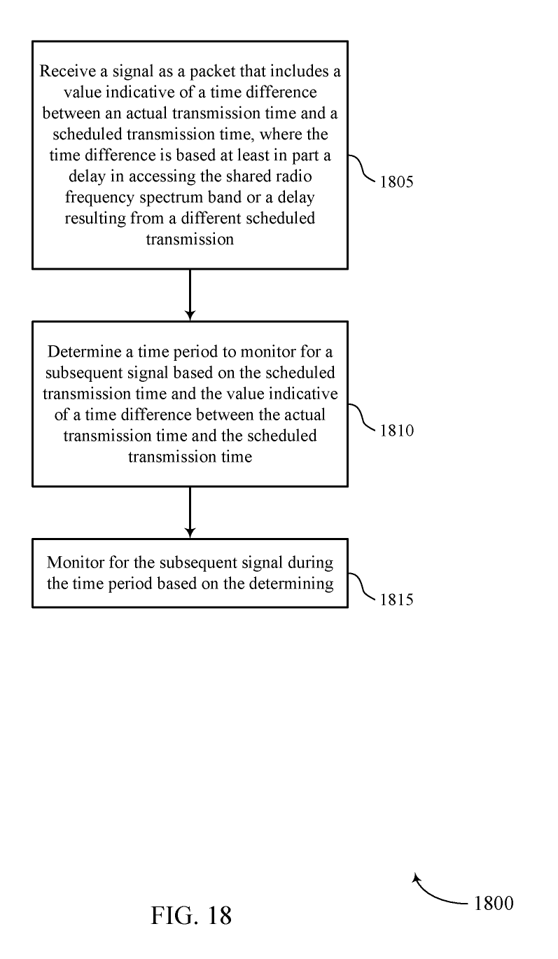

FIG. 18 shows a flowchart illustrating a method 1800 for improved WUR synchronization techniques in accordance with aspects of the present disclosure. The operations of method 1800 may be implemented by a STA 115 or its components as described herein. For example, the operations of method 1800 may be performed by a STA synchronization manager as described with reference to FIGS. 12 through 15. In some examples, a STA 115 may execute a set of codes to control the functional elements of the device to perform the functions described below. Additionally or alternatively, the STA 115 may perform aspects of the functions described below using special-purpose hardware.

At block 1805 the STA 115 may receive a signal as a packet that comprises a value indicative of a time difference between an actual transmission time and a scheduled transmission time, wherein the time difference is based at least in part on a delay in accessing the shared radio frequency spectrum band or a delay resulting from a different scheduled transmission. The operations of block 1805 may be performed according to the methods described herein. In certain examples, aspects of the operations of block 1805 may be performed by a packet manager as described with reference to FIGS. 12 through 15.

At block 1810 the STA 115 may determine a time period to monitor for a subsequent signal based at least in part on the scheduled transmission time and the value indicative of a time difference between the actual transmission time and the scheduled transmission time. The operations of block 1810 may be performed according to the methods described herein. In certain examples, aspects of the operations of block 1810 may be performed by a signal timing manager as described with reference to FIGS. 12 through 15.

At block 1815 the STA 115 may monitor for the subsequent signal during the time period based at least in part on the determining. The operations of block 1815 may be performed according to the methods described herein. In certain examples, aspects of the operations of block 1815 may be performed by a signal monitoring manager as described with reference to FIGS. 12 through 15.

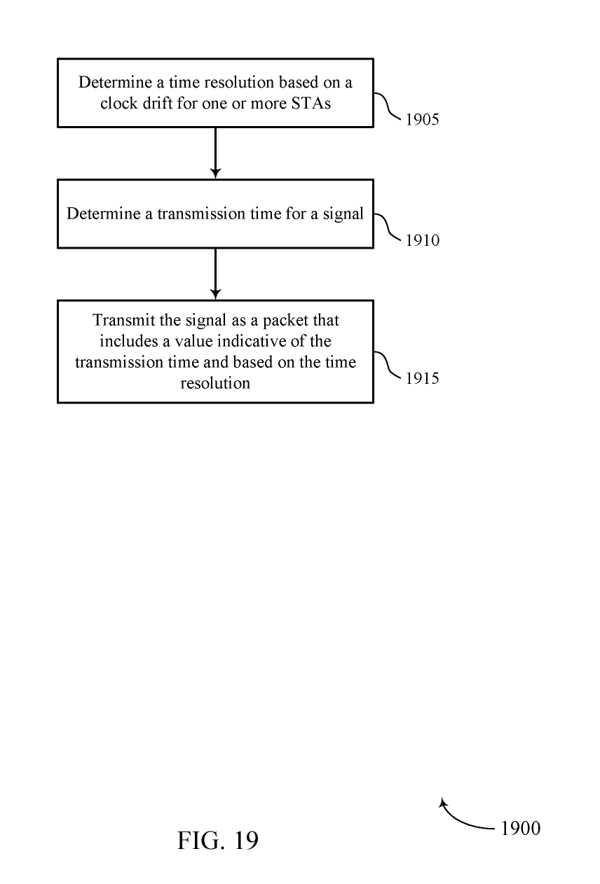

FIG. 19 shows a flowchart illustrating a method 1900 for improved WUR synchronization techniques in accordance with aspects of the present disclosure. The operations of method 1900 may be implemented by an AP 105 or its components as described herein. For example, the operations of method 1900 may be performed by an AP synchronization manager as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1905 the AP 105 may determine a time resolution based at least in part on a clock drift for one or more STAs. The operations of block 1905 may be performed according to the methods described herein. In certain examples, aspects of the operations of block 1905 may be performed by a time resolution manager as described with reference to FIGS. 8 through 11.

At block 1910 the AP 105 may determine a transmission time for a signal. The operations of block 1910 may be performed according to the methods described herein. In certain examples, aspects of the operations of block 1910 may be performed by a transmission timing manager as described with reference to FIGS. 8 through 11.

At block 1915 the AP 105 may transmit the signal as a packet that comprises a value indicative of the transmission time and based at least in part on the time resolution. The operations of block 1915 may be performed according to the methods described herein. In certain examples, aspects of the operations of block 1915 may be performed by a packet manager as described with reference to FIGS. 8 through 11.

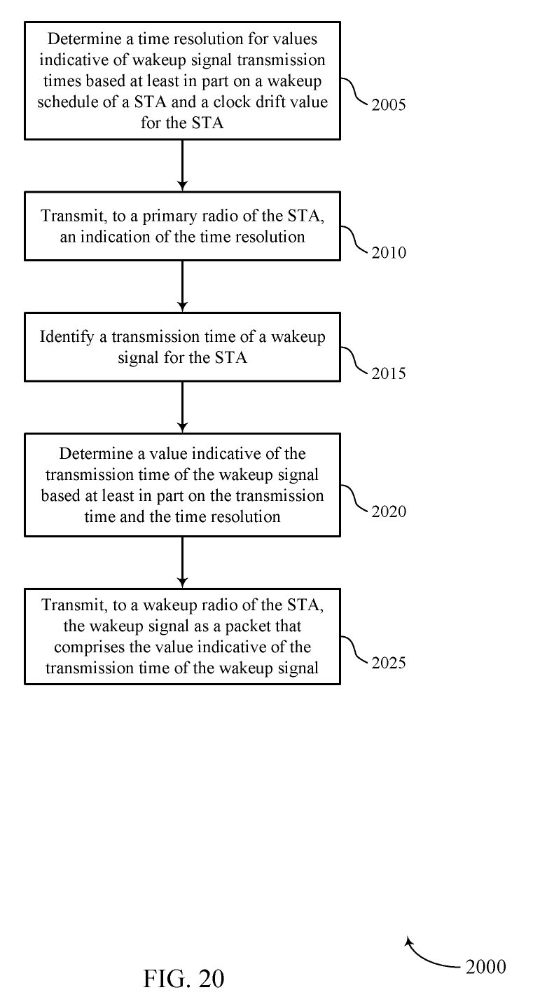

FIG. 20 shows a flowchart illustrating a method 2000 for improved WUR synchronization techniques in accordance with aspects of the present disclosure. The operations of method 2000 may be implemented by an AP 105 or its components as described herein. For example, the operations of method 2000 may be performed by an AP synchronization manager as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 2005 the AP 105 may determine a time resolution for values indicative of wakeup signal transmission times based at least in part on a wakeup schedule of a STA and a clock drift value for the STA. The operations of block 2005 may be performed according to the methods described herein. In certain examples, aspects of the operations of block 2005 may be performed by a time resolution manager as described with reference to FIGS. 8 through 11.

At block 2010 the AP 105 may transmit, to a primary radio of the STA, an indication of the time resolution. The operations of block 2010 may be performed according to the methods described herein. In certain examples, aspects of the operations of block 2010 may be performed by a time resolution manager as described with reference to FIGS. 8 through 11.

At block 2015 the AP 105 may a transmission time of a wakeup signal for the STA. The operations of block 2015 may be performed according to the methods described herein. In certain examples, aspects of the operations of block 2015 may be performed by a transmission timing manager as described with reference to FIGS. 8 through 11.

At block 2020 the AP 105 may determine a value indicative of the transmission time of the wakeup signal based at least in part on the transmission time and the time resolution. The operations of block 2020 may be performed according to the methods described herein. In certain examples, aspects of the operations of block 2020 may be performed by a packet manager as described with reference to FIGS. 8 through 11.

At block 2025 the AP 105 may transmit, to a wakeup radio of the STA, the wakeup signal as a packet that comprises the value indicative of the transmission time of the wakeup signal. The operations of block 2025 may be performed according to the methods described herein. In certain examples, aspects of the operations of block 2025 may be performed by a packet manager as described with reference to FIGS. 8 through 11.

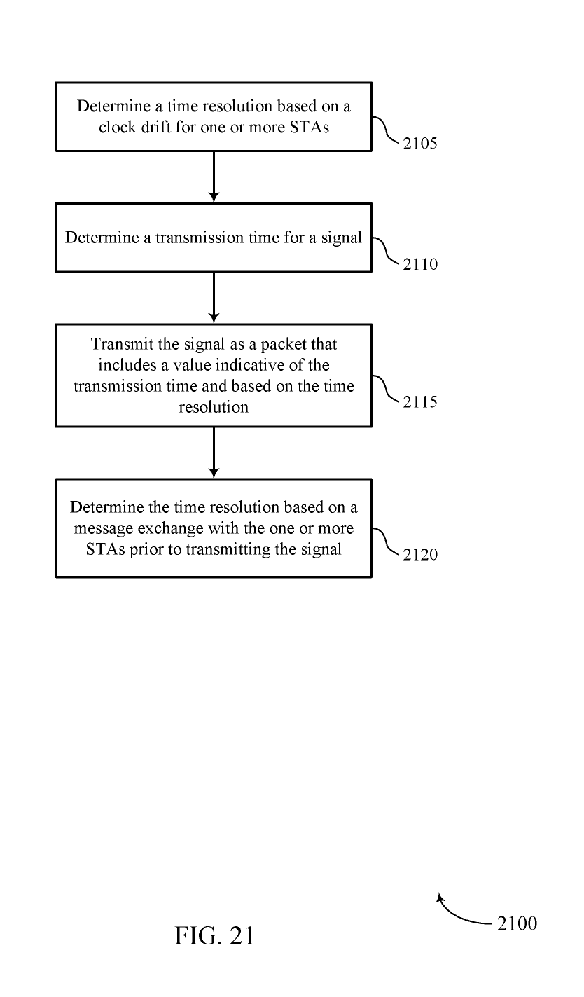

FIG. 21 shows a flowchart illustrating a method 2100 for improved WUR synchronization techniques in accordance with aspects of the present disclosure. The operations of method 2100 may be implemented by an AP 105 or its components as described herein. For example, the operations of method 2100 may be performed by an AP synchronization manager as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 2105 the AP 105 may determine a time resolution based at least in part on a clock drift for one or more stations (STAs). The operations of block 2105 may be performed according to the methods described herein. In certain examples, aspects of the operations of block 2105 may be performed by a time resolution manager as described with reference to FIGS. 8 through 11.

At block 2110 the AP 105 may determine a transmission time for a signal. The operations of block 2110 may be performed according to the methods described herein. In certain examples, aspects of the operations of block 2110 may be performed by a transmission timing manager as described with reference to FIGS. 8 through 11.

At block 2115 the AP 105 may transmit the signal as a packet that comprises a value indicative of the transmission time and based at least in part on the time resolution. The operations of block 2115 may be performed according to the methods described herein. In certain examples, aspects of the operations of block 2115 may be performed by a packet manager as described with reference to FIGS. 8 through 11.

At block 2120 the AP 105 may determine the time resolution based at least in part on a message exchange with the one or more STAs prior to transmitting the signal. The operations of block 2120 may be performed according to the methods described herein. In certain examples, aspects of the operations of block 2120 may be performed by a time resolution manager as described with reference to FIGS. 8 through 11.

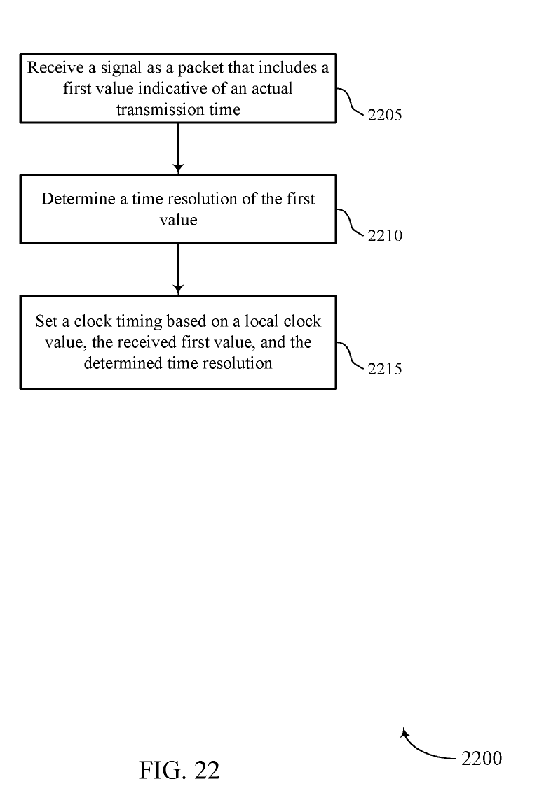

FIG. 22 shows a flowchart illustrating a method 2200 for improved WUR synchronization techniques in accordance with aspects of the present disclosure. The operations of method 2200 may be implemented by a STA 115 or its components as described herein. For example, the operations of method 2200 may be performed by a STA synchronization manager as described with reference to FIGS. 12 through 15. In some examples, a STA 115 may execute a set of codes to control the functional elements of the device to perform the functions described below. Additionally or alternatively, the STA 115 may perform aspects of the functions described below using special-purpose hardware.

At block 2205 the STA 115 may receive a signal as a packet that comprises a first value indicative of an actual transmission time. The operations of block 2205 may be performed according to the methods described herein. In certain examples, aspects of the operations of block 2205 may be performed by a packet manager as described with reference to FIGS. 12 through 15.

At block 2210 the STA 115 may determine a time resolution of the first value. The operations of block 2210 may be performed according to the methods described herein. In certain examples, aspects of the operations of block 2210 may be performed by a time resolution manager as described with reference to FIGS. 12 through 15.

At block 2215 the STA 115 may set a clock timing based at least in part on a local clock value, the received first value, and the determined time resolution. The operations of block 2215 may be performed according to the methods described herein. In certain examples, aspects of the operations of block 2215 may be performed by a clock manager as described with reference to FIGS. 12 through 15.

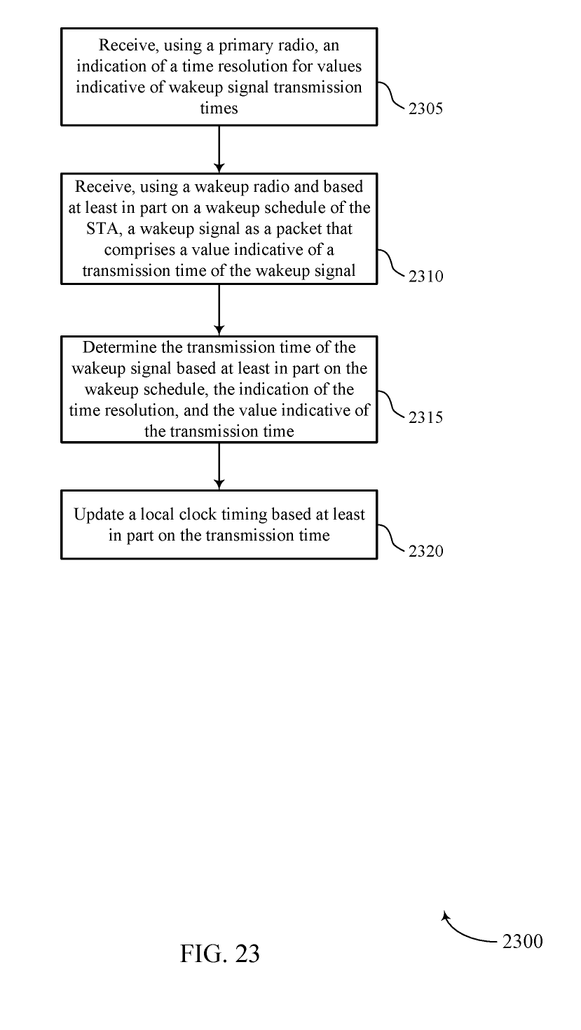

FIG. 23 shows a flowchart illustrating a method 2300 for improved WUR synchronization techniques in accordance with aspects of the present disclosure. The operations of method 2300 may be implemented by a STA 115 or its components as described herein. For example, the operations of method 2300 may be performed by a STA synchronization manager as described with reference to FIGS. 12 through 15. In some examples, a STA 115 may execute a set of codes to control the functional elements of the device to perform the functions described below. Additionally or alternatively, the STA 115 may perform aspects of the functions described below using special-purpose hardware.

At block 2305 the STA 115 may receive, using a primary radio, an indication of a time resolution for values indicative of wakeup signal transmission times. The operations of block 2305 may be performed according to the methods described herein. In certain examples, aspects of the operations of block 2305 may be performed by a primary radio as described with reference to FIG. 1.

At block 2310 the STA 115 may receive, using a wakeup radio and based at least in part on a wakeup schedule of the STA, a wakeup signal as a packet that comprises a value indicative of a transmission time of the wakeup signal. The operations of block 2310 may be performed according to the methods described herein. In certain examples, aspects of the operations of block 2310 may be performed by a packet manager as described with reference to FIGS. 12 through 15.

At block 2315 the STA 115 may determine the transmission time of the wakeup signal based at least in part on the wakeup schedule, the indication of the time resolution, and the value indicative of the transmission time. The operations of block 2315 may be performed according to the methods described herein. In certain examples, aspects of the operations of block 2315 may be performed by a signal timing manager as described with reference to FIGS. 12 through 15.

At block 2320 the STA 115 may update a local clock timing based at least in part on the transmission time. The operations of block 2320 may be performed according to the methods described herein. In certain examples, aspects of the operations of block 2320 may be performed by a clock manager as described with reference to FIGS. 12 through 15.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a station (STA) operating in a shared radio frequency spectrum band, comprising:
a processor;
memory in electronic communication with the processor; and
instructions stored in the memory and executable by the processor to cause the apparatus to:
receive, using a primary radio, an indication of a time resolution for values indicative of wakeup signal transmission times;
receive, using a wakeup radio and based at least in part on a wakeup schedule of the STA, a wakeup signal as a packet that comprises a value indicative of a transmission time of the wakeup signal;
determine the transmission time of the wakeup signal based at least in part on the wakeup schedule, the indication of the time resolution, and the value indicative of the transmission time; and
update a local clock timing based at least in part on the transmission time.

2. The apparatus of claim 1, wherein the time resolution is based at least in part on a clock drift value.

3. The apparatus of claim 2, wherein the instructions are further executable by the processor to cause the apparatus to:
receive, using the primary radio, an indication of a maximum clock drift value, the clock drift value comprising the maximum clock drift value.

4. The apparatus of claim 1, wherein the instructions are further executable by the processor to cause the apparatus to:
determine a set of sequential time values based at least in part on the updated local clock timing and the wakeup schedule; and
receive, using the wakeup radio, a second signal based at least in part on the set of sequential time values and the time resolution.

5. The apparatus of claim 1, wherein the instructions are further executable by the processor to cause the apparatus to:
receive an indication of the wakeup schedule using the primary radio, wherein the wakeup schedule comprises a plurality of time periods for the STA to monitor for wakeup signals.

6. The apparatus of claim 5, wherein the indication of the time resolution comprises a periodicity of the plurality of time periods.

7. The apparatus of claim 1, wherein the value indicative of the transmission time comprises a pattern of bits indicating a partial timing synchronization function (TSF) value for the transmission time.

8. The apparatus of claim 7, wherein the instructions are further executable by the processor to cause the apparatus to:
receive, using the primary radio, an indication of a number of bits in the pattern of bits.

9. The apparatus of claim 7, wherein the packet comprises a first flag that indicates a presence of a field comprising the pattern of bits, or a second flag that indicates that the packet comprises a synchronization frame, or a third flag that indicates that the packet comprises a wakeup frame, or a combination thereof.

10. The apparatus of claim 1, wherein the wakeup signal comprises a wakeup radio (WUR) synchronization beacon or a WUR frame.

11. An apparatus for wireless communication at an access point (AP) operating in a shared radio frequency spectrum band, comprising:
a processor,
memory in electronic communication with the processor; and
instructions stored in the memory and executable by the processor to cause the apparatus to:
determine a time resolution for values indicative of wakeup signal transmission times based at least in part on a wakeup schedule of a station (STA) and a clock drift value for the STA;
transmit, to a primary radio of the STA, an indication of the time resolution;
identify a transmission time of a wakeup signal for the STA;
determine a value indicative of the transmission time of the wakeup signal based at least in part on the transmission time and the time resolution; and
transmit, to a wakeup radio of the STA, the wakeup signal as a packet that comprises the value indicative of the transmission time of the wakeup signal.

12. The apparatus of claim 11, wherein the instructions are further executable by the processor to cause the apparatus to:
transmit, to the STA using the primary radio, an indication of a maximum clock drift value, the clock drift value comprising the maximum clock drift value.

13. The apparatus of claim 11, wherein the instructions are further executable by the processor to cause the apparatus to:
determine a set of sequential time values based at least in part on the wakeup schedule and the transmission time; and
transmit a second signal to the wakeup radio of the STA based at least in part on a next time value of the set of sequential time values.

14. The apparatus of claim 11, wherein the instructions are further executable by the processor to cause the apparatus to:
transmit the wakeup schedule to the primary radio of the STA, wherein the wakeup schedule comprises a plurality of time periods for the STA to monitor for signals from the AP.

15. The apparatus of claim 14, wherein the indication of the time resolution comprises a periodicity of the plurality of time periods.

16. The apparatus of claim 11, wherein the value indicative of the transmission time comprises a pattern of bits indicating a partial timing synchronization function (TSF) value associated with the transmission time.

17. The apparatus of claim 16, wherein the instructions are further executable by the processor to cause the apparatus to:
transmit, to the primary radio of the STA, an indication of a number of bits in the pattern of bits.

18. A method for wireless communication at a station (STA) operating in a shared radio frequency spectrum band, comprising:
receiving, using a primary radio, an indication of a time resolution for values indicative of wakeup signal transmission times;
receiving, using a wakeup radio and based at least in part on a wakeup schedule of the STA, a wakeup signal as a packet that comprises a value indicative of a transmission time of the wakeup signal;
determining the transmission time of the wakeup signal based at least in part on the wakeup schedule, the indication of the time resolution, and the value indicative of the transmission time; and
updating a local clock timing based at least in part on the transmission time.

19. The method of claim 18, further comprising:
determining a set of sequential time values based at least in part on the updated local clock timing and the wakeup schedule; and
receiving, using the wakeup radio, a second signal based at least in part on the set of sequential time values and the time resolution.

20. The method of claim 18, further comprising:
receiving an indication of the wakeup schedule using the primary radio, wherein the wakeup schedule comprises a plurality of time periods for the STA to monitor for wakeup signals.
